(19) United States
(12) Patent Application Publication
(10) Pub. No.: US 2025/0351040 A1
(43) Pub. Date: Nov. 13, 2025

(54) Configuring Inter-DU L1/L2 Mobility Candidates

(71) Applicant: Telefonaktiebolaget LM Ericsson (publ), Stockholm (SE)

(72) Inventors: Icaro Leonardo Da Silva, Solna (SE); Antonino Orsino, Kirkkonummi (FI); Liwei Qiu, Täby (SE); Ioanna Pappa, Stockholm (SE)

(21) Appl. No.: 18/867,597

(22) PCT Filed: Jun. 27, 2023
(86) PCT No.: PCT/SE2023/050662

§ 371 Date: Nov. 20, 2024

Related U.S. Application Data
(60) Provisional application No. 63/356,100, filed on Jun. 28, 2022.

(51) Int. Cl. H04W 36/08; H04W 36/00

(52) U.S. Cl. CPC H04W 36/087; H04W 36/0085

(57) ABSTRACT

Embodiments include methods for a user equipment (UE) configured to communicate with a radio access network (RAN) node comprising a central unit (CU) and a distributed unit (DU). Such methods include receiving, from the CU via the DU, a reconfiguration message that includes configurations associated with each of at least one candidate cell for L1/L2-based inter-cell mobility from a serving cell provided by the DU. The candidate cells are provided by one or more neighbor DUs. Such methods include storing the received configurations and receiving, from the DU, a lower layer signalling message including a command for the UE to change its serving cell to a first candidate cell, for which a configuration was received in the reconfiguration message. Such methods include performing an L1/L2 mobility procedure towards the first candidate cell and communicating in the first candidate cell according to the stored configuration associated with the first candidate cell.

### TECHNICAL FIELD

The present application relates generally to the field of wireless networks, and more specifically to improving mobility of user equipment (UEs) across multiple cells in a wireless network, specifically to cells provided by different distributed units (DUs) that may be associated with a single centralized unit (CU).

### INTRODUCTION

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective Si-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each of the CUs and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

FIG. 2 shows an exemplary configuration of NR user plane (UP) and control plane (CP) protocol stacks between a UE (210), a gNB (220), and an AMF (230). The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On the CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE must perform a random-access (RA) procedure to move from RRC_IDLE to RRC_CONNECTED state, where the cell serving the UE is known and an RRC context is established for the UE in the serving gNB, such that the UE and gNB can communicate. As part of (or in conjunction with) the RA procedure, the UE also transmits an RRCSetupRequest message to the serving gNB.

Long-Term Evolution (LTE) Rel-10 introduced support for channel bandwidths larger than 20 MHz, which continues into NR. To remain compatible with legacy UEs from earlier releases (e.g., Rel-8), a wideband LTE Rel-10 carrier appears as multiple component carriers (CCs), each having the structure of an Rel-8 carrier. The Rel-10 UE can receive multiple CCs based on Carrier Aggregation (CA). The CCs can also be considered “cells”, such that a UE in CA has one primary cell (PCell) and one or more secondary cells (SCells). These are referred to collectively as a “cell group”. NR also supports CA starting in Rel-15.

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a goal of Rel-18 L1/L2 mobility enhancements is to facilitate serving cell change via L1/L2 signaling to address these problems and/or difficulties.

### SUMMARY

These Rel-18 L1/L2 mobility enhancements also must consider the split CU/DU architecture shown in FIG. 1 and discussed above, including for intra-DU and inter-DU/intra-CU cell changes in which the UE's source and target cells are served by different source and target DUs associated with a single CU. However, there are various problems, issues, and/or difficulties.

For example, in the inter-DU/intra-CU scenario, it is unclear what role a neighbor DU (i.e., to the serving DU) should play in configuring a UE with L1/L2 inter-cell mobility. More specifically, it is unclear how the serving CU, the serving DU, and a neighbor DU interact to configure the UE with L1/L2 mobility candidate(s) and other necessary configuration information (e.g., for channel state information, CSI, measurements) to support L1/L2 inter-cell mobility.

An object of embodiments of the present disclosure is to address these and related problems, issues, and/or difficulties, thereby facilitating UE L1/L2 mobility between cells in a RAN (e.g., NG-RAN).

Some embodiments of the present disclosure include methods (e.g., procedures) for a UE configured to communicate with a RAN node comprising a CU and a DU.

These exemplary methods include receiving, from the CU via the DU, a reconfiguration message (e.g., RRCReconfiguration) that includes configurations associated with each of at least one candidate cell for L1/L2-based inter-cell mobility from the serving cell. The candidate cells are provided by one or more neighbor DUs. These exemplary methods also include storing the received configurations and receiving from the DU a lower layer signalling message including a command for the UE to change its serving cell to a first candidate cell, for which a configuration was received in the reconfiguration message. These exemplary methods can also include performing an L1/L2 mobility procedure towards the first candidate cell and communicating in the first candidate cell according to the stored configuration associated with the first candidate cell.

In some embodiments, the one or more neighbor DUs are associated with the CU and/or are part of the RAN node.

Other embodiments include methods (e.g., procedures) for a CU of a RAN node.

These exemplary methods include receiving, from a second DU of the RAN node, configurations associated with each of at least one candidate cell for L1/L2-based inter-cell mobility by a UE from a serving cell provided by a first DU of the RAN node. The at least one candidate cell is provided by the second DU. These exemplary methods also include sending, to the first DU for transmission to the UE, a reconfiguration message that includes the configurations associated with the at least one candidate cell provided by the second DU.

In some embodiments, these exemplary methods can also include sending, to the second DU, a request to configure the UE for L1/L2-based inter-cell mobility from a serving cell provided by a first DU to at least one candidate cell provided by the second DU. The configurations are received in response to the request.

Other embodiments include methods (e.g., procedures) for a second DU of a RAN node.

These exemplary methods can include sending, to a CU of the RAN node, configurations associated with each of at least one candidate cell for L1/L2-based inter-cell mobility by a UE from a serving cell provided by a first DU of the RAN node. The at least one candidate cell is provided by the second DU. These exemplary methods can also include performing an L1/L2 mobility procedure with the UE in a first one of the candidate cells and communicating with the UE in the first candidate cell according to the configuration associated with the first candidate cell.

In some embodiments, these exemplary methods can also include receiving from the CU a request to configure the UE for L1/L2-based inter-cell mobility from a serving cell provided by a first DU to at least one candidate cell provided by the second DU. In such embodiments, the configurations are sent in response to the request.

Other embodiments include UEs, CUs, and DUs configured to perform operations corresponding to any of the exemplary methods described herein. Other embodiments also include non-transitory, computer-readable media storing computer-executable instructions that, when executed by processing circuitry, configure such UEs, CUs, and DUs to perform operations corresponding to any of the exemplary methods described herein.

These and other embodiments can facilitate configuring a UE with one or more L1/L2 inter-cell mobility candidate cells associated with a neighbor DU, which allows the UE to move further in its coverage area and still be able to perform/execute L1/L2 inter-cell mobility. This promotes more efficient signaling, reduced processing, and reduced interruption time compared to a L3 (e.g., RRC) handover. Embodiments also maintain L1/L2 mobility interoperability between the UE, the serving DU/CU, and the neighbor DU without ambiguities.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level view of an exemplary 5G network architecture.

FIG. 2 shows an exemplary configuration of NR UP and CP protocol stacks.

FIGS. 3-4 show logical architectures for a gNB arranged in the split CU/DU architecture illustrated by FIG. 1.

FIG. 5 shows a signaling flow between a UE, a DU, a CU, and an AMF for a UE initial access procedure.

FIG. 6, which includes FIGS. 6A-F, shows various ASN.1 data structures for configuring a UE with L1/L2 inter-cell mobility candidates, according to various embodiments of the present disclosure.

FIG. 7 shows signaling for an exemplary procedures for a CU to configure a UE with L1/L2 inter-cell mobility candidates from a neighbor DU, according to some embodiments of the present disclosure.

FIGS. 8-9 show signaling for two exemplary procedures for a CU to configure a UE with L1/L2 inter-cell mobility candidates from two different neighbor DUs, according to various embodiments of the present disclosure.

FIG. 10 shows an exemplary method (e.g., procedure) for a UE, according to various embodiments of the present disclosure.

FIG. 11 shows an exemplary method (e.g., procedure) for a CU, according to various embodiments of the present disclosure.

FIG. 12 shows an exemplary method (e.g., procedure) for a DU, according to various embodiments of the present disclosure.

FIG. 13 shows a communication system according to various embodiments of the present disclosure.

FIG. 14 shows a UE according to various embodiments of the present disclosure.

FIG. 15 shows a network node according to various embodiments of the present disclosure.

FIG. 16 shows host computing system according to various embodiments of the present disclosure.

FIG. 17 is a block diagram of a virtualization environment in which functions implemented by some embodiments of the present disclosure may be virtualized.

FIG. 18 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

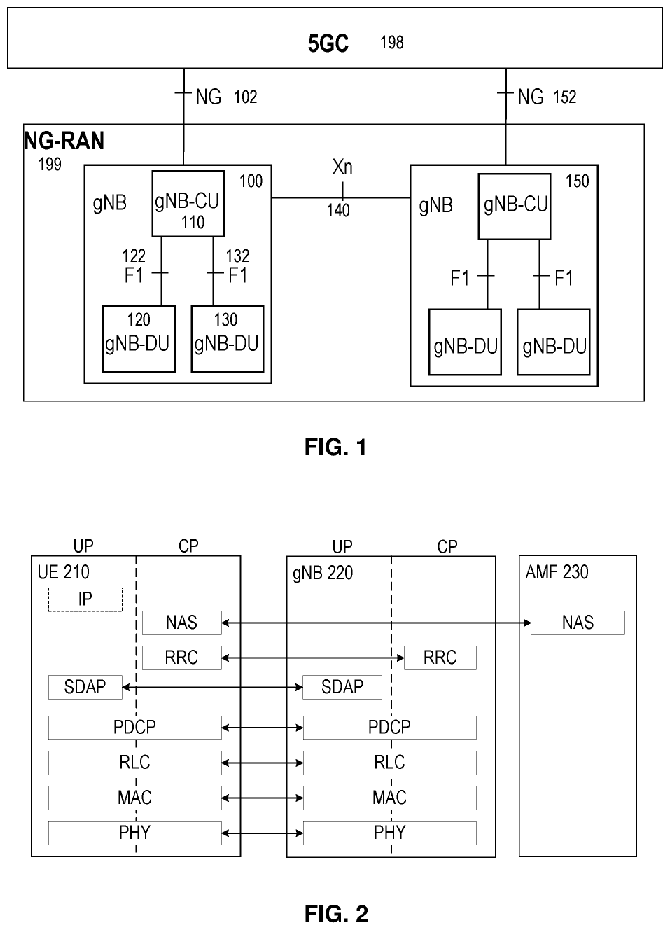

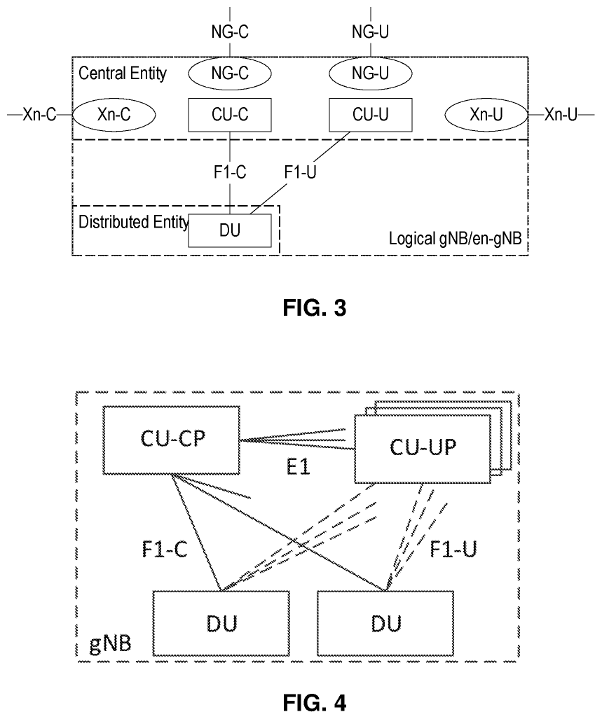

FIG. 3 shows a logical architecture for a gNB arranged in the split CU/DU architecture, such as the gNB (100) in FIG. 1. This logical architecture separates the CU into CP and UP functionality, called CU-C and CU-U respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 3 refer to physical network nodes.

FIG. 4 shows another exemplary gNB logical architecture that includes two gNB-DUs, a gNB-CU-CP, and multiple gNB-CU-UPs. The gNB-CU-CP may be connected to the gNB-DU through the F1-C interface, and the gNB-CU-UP may be connected to the gNB-DU through the F1-U interface and to the gNB-CU-CP through the E1 interface. Each gNB-DU may be connected to only one gNB-CU-CP, and each gNB-CU-UP may be connected to only one gNB-CU-CP. One gNB-DU may be connected to multiple gNB-CU-UPs under the control of the same gNB-CU-CP.

Also, one gNB-CU-UP may be connected to multiple DUs under the control of the same gNB-CU-CP. When referring herein to an operation performed by a “CU”, it should be understood that this operation can be performed by any entities within the CU (e.g., CU-CP, gNB-CU-CP) unless stated otherwise.

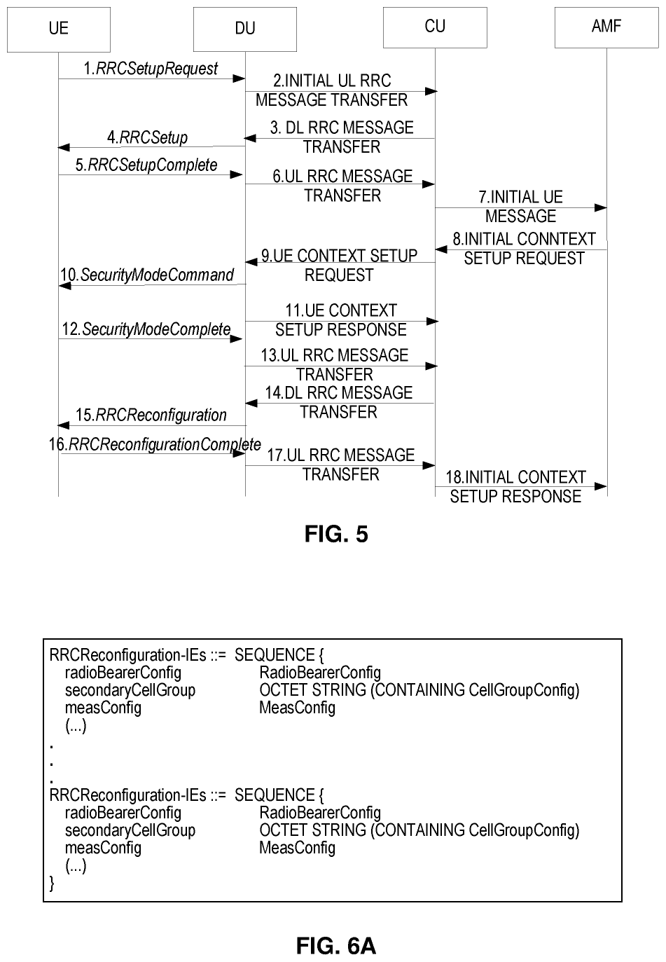

As briefly mentioned above, a UE must perform a random-access (RA) procedure to move from RRC_IDLE to RRC_CONNECTED state. As part of (or in conjunction with) the RA procedure, the UE also transmits an RRCSetupRequest message to the serving gNB. FIG. 5 shows a signaling flow for a UE initial access procedure between a UE, a DU, a CU, and an AMF. Although the operations shown in FIG. 5 are given numerical labels, this is done to facilitate explanation rather than to require or imply any particular operational order, unless expressly stated otherwise.

In operation 1, the UE sends an RRCSetupRequest message to the DU. In operation 2, the DU includes the RRC message and, if the UE is admitted, the corresponding low-layer configuration for the UE in the INITIAL UL RRC MESSAGE TRANSFER message to the CU. The INITIAL UL RRC MESSAGE TRANSFER message includes the C-RNTI allocated by the DU.

In operation 3, the CU allocates a gNB-CU UE F1AP ID for the UE and generates a RRCSetup message towards UE. The RRC message is encapsulated in the DL RRC MESSAGE TRANSFER message. In operation 4, the DU sends the RRCSetup message to the UE. In operation 5, the UE sends the RRC CONNECTION SETUP COMPLETE message to the DU. In operation 6, the DU encapsulates the RRC message in the UL RRC MESSAGE TRANSFER message and sends it to the CU.

In operation 7, the CU sends the INITIAL UE MESSAGE to the AMF. In operation 8, the AMF sends the INITIAL CONTEXT SETUP REQUEST message to the CU. In operation 9, the CU sends the UE CONTEXT SETUP REQUEST message to establish the UE context in the DU. In this message, it may also encapsulate the SecurityModeCommand message. In case of NG-RAN sharing, the CU includes the serving PLMN ID (for SNPNs the serving SNPN ID). In operation 10, the DU sends the SecurityModeCommand message to the UE.

In operation 11, the DU sends the UE CONTEXT SETUP RESPONSE message to the CU. In operation 12, the UE responds with the SecurityModeComplete message. In operation 13, the DU encapsulates the RRC message in the UL RRC MESSAGE TRANSFER message and sends it to the CU. In operation 14, the CU generates the RRCReconfiguration message and encapsulates it in the DL RRC MESSAGE TRANSFER message.

In operation 15, the DU sends RRCReconfiguration message to the UE. In operation 16, the UE sends RRCReconfigurationComplete message to the DU. In operation 17, the DU encapsulates the RRC message in the UL RRC MESSAGE TRANSFER message and send it to the CU. In operation 18, the CU sends the INITIAL CONTEXT SETUP RESPONSE message to the AMF.

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a high-level goal of the Rel-18 L1/L2 mobility enhancements is to facilitate serving cell change via L1/L2 signaling to address these problems and/or difficulties. Some more specific goals include:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

These Rel-18 L1/L2 mobility enhancements also must take into account the split CU/DU architecture shown in FIGS. 1 and 3-4, including for intra-DU and inter-DU/intra-CU cell changes. In the inter-DU/intra-CU scenario, the candidate cell for L1/L2 inter-cell mobility is a cell served by a neighbor DU to the (serving or source) DU that currently provides the UE's PCell (or PSCell, for SCG change in DC).

However, the UE initial access procedure shown in FIG. 5 does not consider L1/L2 inter-cell mobility. Instead, a UE context is setup in the UE's serving DU as requested by the CU with a UE CONTEXT SETUP REQUEST message (operation 9), since that DU serves the cell that the UE attempts to access. At a later time (not shown in FIG. 5), once the UE is in RRC_CONNECTED, the CU may trigger a modification of that UE context already setup at the DU, e.g., by sending a UE CONTEXT MODIFICATION REQUEST to the serving DU.

In the inter-DU/intra-CU scenario, it is unclear what role a neighbor DU (i.e., to the serving DU) should play in configuring a UE with L1/L2 inter-cell mobility. More specifically, it is unclear how the serving CU, the serving DU, and a neighbor DU interact to configure the UE with L1/L2 mobility candidate(s) and other necessary configuration information (e.g., for channel state information, CSI, measurements) to support L1/L2 inter-cell mobility.

Embodiments of the present disclosure address these and other problems, difficulties, and/or issues by providing flexible and efficient signaling techniques that facilitate configuring the UE with intra-CU/inter-DU L1/L2 based inter-cell mobility. At a high level, embodiments include communication between the UE, the CU serving the UE, the DU serving the UE, and at least one neighbor DU being requested by the CU to configure one or more L1/L2 inter-cell mobility candidate cells for the UE.

For example, the CU can transmit a message to setup a UE context in a neighbor DU (i.e., not the DU that provides the UE's current PCell) for configuring the UE with inter-DU L1/L2 inter-cell mobility. The neighbor DU can generate a configuration that the UE can apply upon the execution of inter-DU L1/L2 inter-cell mobility procedure (e.g., handover), after which the UE starts operating according to the applied configuration in the target cell provided by the neighbor DU.

Various embodiments include operations such as the CU sending a UE CONTEXT SETUP REQUEST to request each candidate cell to the neighbor DU, the CU sending a UE CONTEXT SETUP REQUEST to request multiple candidate cells to the neighbor DU, and/or the CU requesting a single or multiple neighbor DUs for one or more L1/L2 inter-cell mobility candidates. In contrast to conventional L3 handover/reconfiguration with sync, the neighbor DU is responsible for the incoming UE.

Embodiments can provide various benefits and/or advantages. For example, embodiments can facilitate configuring a UE with one or more L1/L2 inter-cell mobility candidate cells (also referred to as “L1/L2 inter-cell mobility candidates”) associated with a neighbor DU, which allows the UE to move further in its coverage area and still be able to perform/execute L1/L2 inter-cell mobility. This promotes more efficient signaling, reduced processing, and reduced interruption time compared to a L3 handover/reconfiguration with sync. Moreover, embodiments also maintain L1/L2 mobility interoperability between the UE, the serving DU/CU, and the neighbor DU without ambiguities.

In the present disclosure, the following terms may be used interchangeably: “L1/L2 based inter-cell mobility” (as used in the 3GPP Work Item), “L1/L2 mobility,” “L1-mobility,” “L1 based mobility,” “L1/L2-centric inter-cell mobility,” “L1/L2 inter-cell mobility,” “inter-cell beam management,” and “inter-DU L1/L2 based inter-cell mobility”. These terms refer to a scenario in which a UE receives lower-layer (i.e., below RRC, such as MAC or PHY) signaling from a network indicating for the UE to change of its serving cell (e.g., PCell) from a source cell to a target cell. Compared to conventional RRC signaling, lower layer signaling reduces processing time and interruption time during mobility and may also increase mobility robustness since the network can respond more quickly to changes in the UE's channel conditions.

Another relevant aspect in L1/L2 inter-cell mobility is that a cell can be associated with multiple SSBs (or beams), with different SSBs being transmitted in different spatial directions during a half frame, thereby spanning the coverage area of a cell. A cell may also be associated with multiple CSI-RS resources, which may be transmitted in different spatial directions. Hence, in L1/L2 inter-cell mobility, the reception of lower layer signaling indicating for the UE to change from one beam in its serving cell to another beam in a (candidate) neighbor cell, which also involves changing serving cell.

In the present disclosure, the following terms may be used interchangeably with respect to L1/L2 inter-cell mobility: “neighbor DU,” “non-Serving DU,” and “candidate DU.” The following description refers to one or more configurations generated by a neighbor DU, that are encapsulated in an RRCReconfiguration message, which is received by the UE when configured for inter-DU L1/L2 inter-cell mobility. The configuration(s) can include various information according to different embodiments summarized below.

In some embodiments, the one or more configurations generated by the neighbor DU, and encapsulated in an RRCReconfiguration message can include at least one configuration of a L1/L2 based inter-cell mobility candidate cell. For each candidate cell, this information includes the configuration which the UE needs to operate in that candidate cell after completing the L1/L2 inter-cell mobility procedure, at which time the candidate cell becomes the target cell and the UE's new PCell (or an SCell in a serving frequency). In the case the UE is configured with multiple candidates, the neighbor DU generates and sends to the CU multiple configuration(s) of multiple L1/L2 based inter-cell mobility candidate cell(s).

A configuration of an L1/L2 based inter-cell mobility candidate cell can include parameters of a serving cell (or multiple serving cells), comprising one or more of the groups of parameters within the SpCellConfig information element (IE) (or SCellConfig IE, in the case of an SCell). These parameters can include any of the following:
cell index (e.g., encoding fewer bits than the cell identifier of the L1/L2 inter-cell mobility candidate cell). That may be a field ‘servCellIndex’ or ‘candidateCellIndex’ of IE ‘ServCellIndex’ or IE ‘CandidateCellIndex’. After this being configured, the index may be later used in lower layer signaling to indicate to the UE that this is the candidate cell the UE needs to move to in the L1/L2 inter-cell mobility procedure, and/or in an RRC message indicating some operation in that particular candidate cell.
UE (e.g., UE-specific or UE-dedicated) cell configuration corresponding to the configuration of a L1/L2 based inter-cell mobility candidate cell, with parameters possibly adjusted for the UE according to UE capabilities. The UE cell configuration may include parameters defined in the ServingCellConfig IE (defined in 3GPP TS 38.331) such as DL and UL frequency configurations (including Bandwidth parts), L1 control channels (such as PDCCH, CORESETs, PUCCH), L1 data channels (such as PDSCH, PUSCH), etc.
common cell configuration corresponding to the configuration of a L1/L2 based inter-cell mobility candidate cell in the ServingCellConfigCommon IE. That may be provided within the ReconfigurationWithSync IE or separately. This common cell configuration contains, for example, a RA configuration for the UE to access the candidate cell, if necessary.
Radio Link Failure configuration(s) such as values for timer T310, counter N310, counter N311, timer N311.
At least one UE identifier to identify the UE in the L1/L2 based inter-cell mobility candidate cell such as a Cell Radio Network Temporary Identifier (C-RNTI).

In some embodiments, when the UE is configured with multiple L1/L2 inter-cell mobility candidate cells provided by the neighbor DU, the neighbor DU generates and sends to the CU, multiple sets of parameters within multiple SpCellConfig IEs. For example, the UE may receive a list of SpCellConfig IEs, one for each L1/L2 inter-cell mobility candidate.

In some embodiments, the configuration of a L1/L2 based inter-cell mobility candidate cell of the neighbor DU may be the SpCell configuration provided as part of a cell group configuration (e.g., PCell for MCG), and may also include one or more SCell configurations and cell group-specific configurations (e.g., cell group identity, cell group PHY configuration, cell group MAC configuration, simultaneous TCI state configurations for the cell group, etc.). In these embodiments, the UE is configured with a cell group configuration per neighbor DU candidate cell. One alternative is the UE to receive one configuration per cell group, where the configuration of a L1/L2 based inter-cell mobility candidate cell is the SpCell candidate configuration within that group. Then, the lower layer signaling indicates the UE to change to a configured cell group candidate, e.g., to change from an MCG configuration A to an MCG configuration B.

In some embodiments, when the UE is configured with multiple L1/L2 inter-cell mobility candidates, the neighbor DU generates and sends to the CU multiple cell group configurations, each associated with a different candidate. For example, the neighbor DU can generate and send a list of CellGroupConfig IEs.

In some embodiments, an L1/L2 inter-cell mobility candidate may be in the same frequency as the current PCell, or in a different frequency. In some embodiments, the L1/L2 inter-cell mobility candidate may be an SCell candidate.

RRC signaling implementation for the configuration of a L1/L2 based inter-cell mobility candidate cell can be done in different ways corresponding to various embodiments. Some examples are described below.

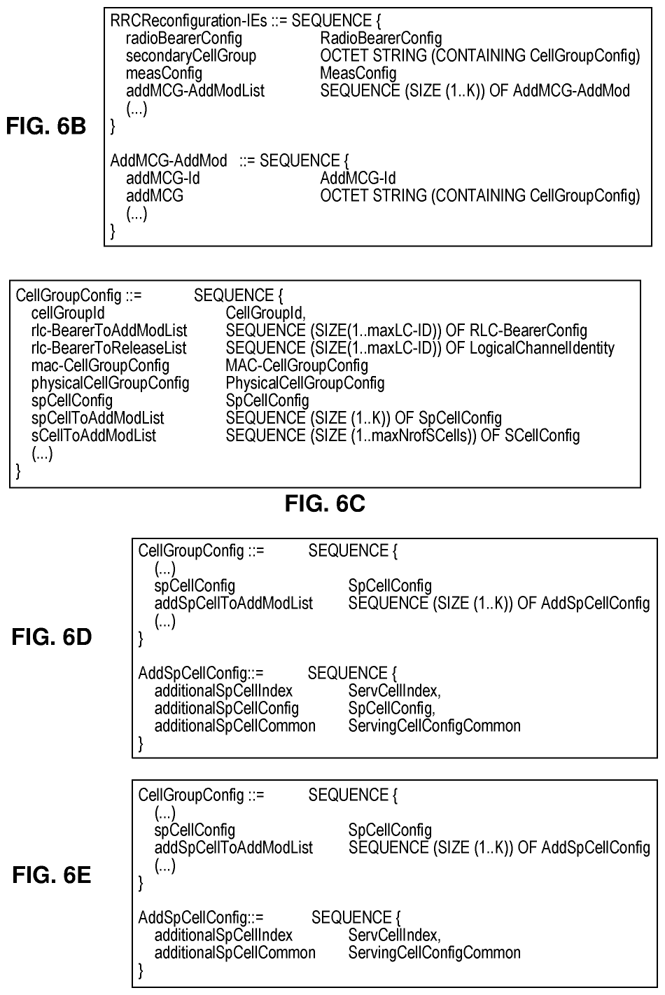

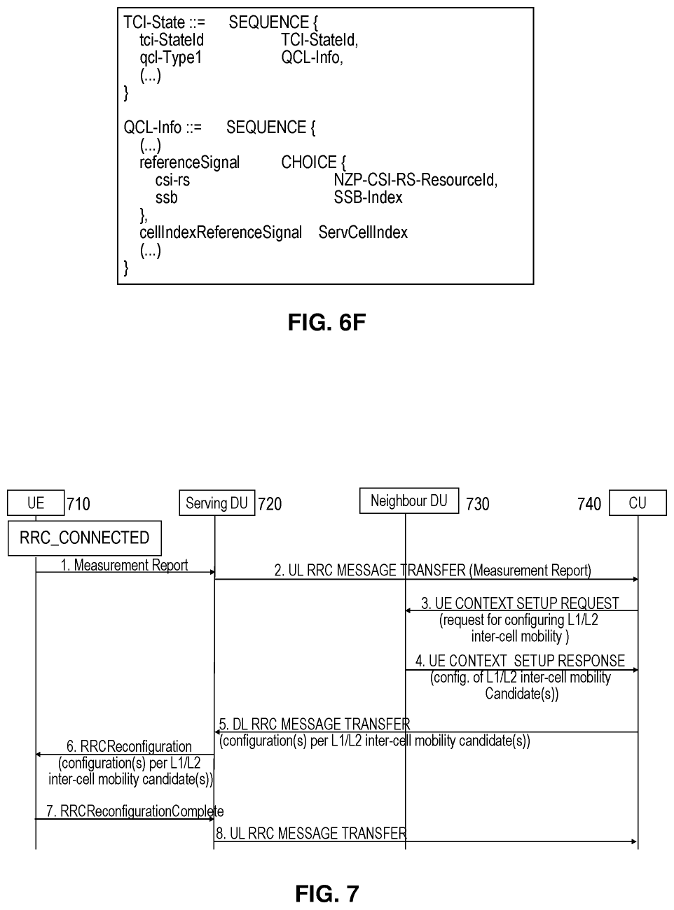

Some embodiments can utilize one RRCReconfiguration message per candidate cell. In this case the UE receives multiple (a list of) RRCReconfiguration messages within a single RRCReconfiguration message, as illustrated in FIG. 6A. Each RRCReconfiguration message identifies and/or includes a configuration of a L1/L2 based inter-cell mobility candidate cell that is stored by the UE and is applied/used/activated when receiving the lower layer signaling for the corresponding L1/L2 inter-cell mobility procedure to that candidate cell. This model enables the full flexibility, as in L3 reconfigurations, for the target node to modify/release/maintain any parameter/field in the existing RRCReconfiguration message (e.g., measurement configuration, bearers, etc.).

As an example of these embodiments, the neighbor DU generates a CellGroupConfig IE for each candidate (including candidate SpCell and SCell(s), as applicable) and the CU generates the RRCReconfiguration message per candidate based on the respective CellGroupConfig IEs. These are received by the UE and stored, to be applied if/when the UE later receives a L1/L2 inter-cell mobility command (e.g., MAC CE) indicating a particular one of the candidate cells.

Other embodiments can utilize one CellGroupConfig IE per candidate cell. With this model the UE receives within an RRCReconfiguration message a list of CellGroupConfig IEs, with each IE identifying and/or including a configuration of a L1/L2 based inter-cell mobility candidate cell. FIG. 6B shows an example of these embodiments. Each CellGroupConfig IE is stored by the UE and is applied/used/activated when receiving the lower layer signaling for the corresponding L1/L2 inter-cell mobility procedure to that candidate cell. This model allows the neighbor DU to modify/release/keep any parameter/field that is part of a CellGroupConfig 1E while the rest of the RRCReconfiguration message (in which the CellGroupConfig IE is received by the UE) remains unchanged. This means that measurement configuration, bearers, security, etc. remain the same and are not changed by the target node.

As an example of these embodiments, the neighbor DU generates the CellGroupConfig 1E for each target candidate (including the candidate SpCell and SCells associated) and the CU generates the RRCReconfiguration message with the list of CellGroupConfig IEs. These are received by the UE and stored, to be applied if/when the UE later receives a L1/L2 inter-cell mobility command (e.g., MAC CE) indicating a particular one of the candidate cells.

Other embodiments can provide the UE with a plurality (K) of SpCellConfig IEs and/or a plurality (K) of ServingCellConfigCommon IEs in a configuration of a L1/L2 based inter-cell mobility candidate cell. This solution provides only minimum flexibility for the neighbor DU since only cell-specific parameters (e.g., bandwidth parts, DL/UL configurations) can be modified/released/kept by the neighbor DU when generating the K SpCellConfig IEs and/or the K ServingCellConfigCommon IEs to be provided to the UE. FIGS. 6C-E show examples of these embodiments.

Other embodiments can provide the UE with a plurality (K) of physical cell identifiers (PCI) in the same PCell. FIG. 6F shows an example of these embodiments. With this model multiple PCIs are configured for the same TCI state configuration, where each PCI identifies a configuration of an L1/L2 based inter-cell mobility candidate cell. This approach that provide no flexibility at all since all the parameters/fields used for configuring a configuration of a L1/L2 based inter-cell mobility candidate cell are fixed and only a change of PCI, scrambling Id, and/or C-RNTI is allowed for the neighbor DU.

FIG. 7 shows a signaling flow for configuring a UE for inter-DU L1/L2 inter-cell mobility in a neighbor DU, according to some embodiments of the present disclosure. Although the operations shown in FIG. 7 are given numerical labels, this is done to facilitate explanation rather than to require or imply any particular operational order, unless expressly stated otherwise.

In operation 1, a UE (710) that is capable of L1/L2 inter-cell mobility sends to a serving DU (720) a measurement report including one or more measurements of one or more cells of a neighbor DU, which may become L1/L2 inter-cell mobility candidate cells in a first frequency. The neighbor DU (730) does not provide the UE's current PCell has an association (e.g., F1AP connection) with the CU (740) currently serving the UE. For example, the measurement report can be sent after Access Stratum (AS) security has been activated.

The one or more measurements of the one or more cells of the neighbor DU in a first frequency may be measurement of cells in the same (or different) frequency as the UE's PCell, or intra-frequency neighbors of the PCell, or neighbors of the UE's SCell(s). For example, the measurements can include reference signal received power (RSRP), reference signal received quality (RSRQ), signal-to-interference-and-noise ratio (SINR), etc. of SSB or CSI-RS transmitted in the one or more cells.

In some embodiments, the measurement report is an RRC message (MeasurementReport) that includes a MeasResults IE, as defined in 3GPP TS 38.331. In some embodiments, the measurement report is a PHY CSI report transmitted via an uplink channel (e.g., PUCCH, PUSCH) of the PCell or one of the configured SCell(s).

In some embodiments, before transmitting the measurement report the UE receives a first message including a measurement configuration for measuring at least one cell and/or frequency of a neighbor DU. The measurement configuration can include a reporting configuration including a triggering condition for sending the measurement report.

In some embodiments, when the measurement report corresponds to an RRC Measurement Report, the measurement configuration can be an MeasConfig IE received in an RRC message (e.g., RRCReconfiguration), and the reporting configuration corresponds to an ReportConfig IE, which may configure a periodic or event-based measurement report. For periodic, the triggering condition is expiration of a timer and/or a configured periodicity. For event-triggered (e.g., A4 or A3 event), triggering condition is occurrence of the corresponding event, e.g., measurements on a neighbor cell at least a configured offset better than measurement on the PCell for a period of time longer than a configured duration.

In the specific case of A4 event, the triggering condition for sending the measurement report is that one or more measurement quantities (e.g., RSRP, RSRQ or/and SINR) for at least one neighbor cell (or a possible L1/L2 inter-cell mobility candidate) becomes better than a configured threshold. In other words, if the UE detects at least one cell whose measurements fulfills the A4 condition, the UE transmits the RRC Measurement Report and includes one or more measurement for the at least one cell of the neighbor DU. The reasoning here is that a cell which may trigger the report is considered as a neighbor as it is not the PCell, which is the cell the UE is configured with in the PCell frequency. The Measurement Object for the neighbor, in the case of intra-frequency, is the same frequency as the PCell.

In the specific case of A4 event, the triggering condition for sending the measurement report is that one or more measurement quantities (e.g., RSRP, RSRQ or/and SINR) for at least one neighbor cell (or a possible L1/L2 inter-cell mobility candidate) becomes more than a configured threshold better than corresponding measurement quantities for the UE's current PCell. In other words, if the UE detects at least one cell whose measurements fulfills the A3 condition, the UE transmits the RRC Measurement Report and includes one or more measurements for the at least one cell of the neighbor DU.

In some embodiments, when the measurement report corresponds to a CSI report, the measurement configuration may correspond to the CSI-MeasConfig IE received in an RRC message (e.g., RRCReconfiguration). This IE includes a CSI-ReportConfig IE that configure a periodic, aperiodic, semi-persistent, and/or event-triggered CSI report. In the case of event-triggered, the condition may be similar to the ones defined for RRC measurement reports.

In operation 2, the serving DU receives the measurement report including measurements of one or more cells of the neighbor DU and includes the measurement report in an UL RRC MESSAGE TRANSFER message to the CU.

In some embodiments, upon reception of the measurement report, the CU determines to configure the UE with one or more L1/L2 inter-cell mobility candidate cell(s) of a neighbor DU. The CU may determine that based on at least one capability related to L1/L2 inter-cell mobility of the UE that sent the measurement report, e.g., that the UE is capable of being configured with (and perform a mobility procedure towards) at least one candidate cell associated with a neighbor DU.

In some embodiments, the CU can identify that the one or more cells included in the measurement report are associated with a neighbor DU in various ways. For example, the CU may determine that it has an interface, association (e.g., F1AP), and/or sufficient addressing information for the neighbor DU, that facilitates requesting setup of a UE context for L1/L2 inter-cell mobility. This may be determined by the information in the measurement report, such as PCI and frequency per neighbor cell, in conjunction with neighbor relation information the CU has for its associated DU(s). In some variants, upon identifying the neighbor DU, the CU can determine whether the neighbor DU is capable of configuring the UE with at least one with L1/L2 inter-cell mobility candidate cell (e.g., according to any of the ways discussed above).

In some embodiments, upon reception of the measurement report, the CU selects one or more L1/L2 inter-cell mobility candidate cell(s) of the neighbor DU from the neighbor cells included in the measurement report. This can be done in various ways according to various criteria. For example, the CU can select one or more cells in the measurement report whose measurement quantity (e.g., RSRP, RSRQ, SINR) are the best, strongest, highest, or otherwise most favorable. For example, if the measurement report includes K cells but the UE is capable of being configured with K1<K L1/L2 inter-cell mobility candidates, the CU selects at most the K1 cells having the highest RSRP values. This selection of the candidate cells of the neighbor DU can also be based on neighbor DU capabilities, as discussed above.

In operation 3, the CU sends a second message to the neighbor DU, indicating a request for the neighbor DU to configure the UE with L1/L2 based inter-cell mobility, i.e., to configure one or more cells and/or cell groups that are L1/L2 inter-cell mobility candidates.

In some embodiments, the CU transmits a second message to the neighbor DU, indicating a request for the neighbor DU to configure the UE with one L1/L2 based inter-cell mobility candidate cell of the neighbor DU. The neighbor DU receives the second message and transmits the third message to the CU.

In other embodiments, the CU sends multiple second messages to the neighbor DU, each second message indicating a request for the neighbor DU to configure the UE with one L1/L2 based inter-cell mobility candidate cell of the neighbor DU. The neighbor DU receives the multiple second messages and responds with a corresponding multiple third messages. In these embodiments, each L1/L2 inter-cell mobility candidate cell of the neighbor DU is associated with a different exchange of second and third messages, i.e., one procedure per candidate.

In other embodiments, the CU transmits a second message to the neighbor DU, indicating a request for the neighbor DU to configure the UE with multiple L1/L2 based inter-cell mobility candidate cells of the neighbor DU. The neighbor DU receives the second message and transmits a third message including a plurality of configurations, each corresponding to an L1/L2 based inter-cell mobility candidate cell provided by the neighbor DU.

When multiple neighbor DUs are involved, the CU can use any combination of the above second/third message exchange embodiments with the respective neighbor DUs. For example, the CU may send a single second message concerning one candidate target cell to a first neighbor DU, send a single second message concerning multiple candidate target cells to a second neighbor DU, and send a plurality of second messages concerning a respective plurality of candidate target cells to a third neighbor DU.

In some embodiments, the second message is a message used to request the setup a UE context in a neighbor DU for preparing the neighbor DU for a L1/L2 inter-cell mobility procedure (inter-DU). For example, the second message may correspond to a UE CONTEXT SETUP REQUEST message over the F1AP interface.

In various embodiments, the second message from the CU to the neighbor DU may include one or more of the following:
a set of candidates to be UE SpCell/PCell;
a set of candidates to be UE SCell(s); and/or
a set of candidate cell groups, including an SpCell L1/L2 inter-cell mobility candidate and at least one SCell associated to the SpCell L1/L2 inter-cell mobility candidate. One reason to include SCell candidates in the second message is that L1/L2 inter-cell mobility should work with CA. Upon executing L1/L2 inter-cell mobility to an SpCell/PCell target cell of the neighbor DU, the UE needs to be able to perform CA based on a configuration provided by the neighbor DU.

In some embodiments, the second message includes the UE's one or more measurements (or a subset thereof) for cells of the neighbor DU, or other content of the UE's measurement report (e.g., in an RRC container from CU to neighbor DU). Based on this, the neighbor DU may determine which of its cells to configure as L1/L2 inter-cell mobility candidates for the UE. In one option, the request from the CU includes the measurement information but not the “recommended” cells, in which case the DU selects which cells are to be configured as L1/L2 inter-cell mobility candidates based on the measurement information. In another option, the request includes the measurement information and the “recommended” cells.

In some embodiments, the CU sends the second message based on an indication that the UE is capable of L1/L2 based inter-cell mobility. In some embodiments, the CU sends the second message based on an indication that the UE is capable of inter-DU L1/L2 based inter-cell mobility (i.e., between cells of different DUs). In some embodiments, the CU can obtain this indication from the 5GC, e.g., in an Initial Context Setup Request from AMF. In other embodiments, the CU can obtain this indication from its own storage or another repository in the network (e.g., unified data repository, UDR).

In some embodiments, the CU receives a third message from one or more neighbor DU(s), each including the least one configuration of a L1/L2 based inter-cell mobility candidate cell of each neighbor DU, even without sending a second message to one or more neighbor DU(s). This can occur, for example, when a neighbor DU wants to update an existing configuration of a L1/L2 based inter-cell mobility candidate cell of each neighbor DU or to provide an additional configuration of a L1/L2 based inter-cell mobility candidate cell of each neighbor DU.

For example, the RRCReconfiguration received by the UE can include an AddMod list structure in which each list element is a configuration of a L1/L2 based inter-cell mobility candidate cell and an associated identifier. The configuration is considered to be added when the associated identifier has not yet been added at the UE, indicating a new candidate. If the associated identifier matches an identifier the UE has stored, that indicates the stored configuration for that identifier is to be modified by the newly received configuration. Delta configurations can be used for this purpose, as needed.

Upon receiving the second message, if the neighbor DU accepts the request for configuring L1/L2 inter-cell mobility for the UE, the neighbor DU generates one or more of the following:
at least one CSI measurement configuration; and
at least one configuration of a L1/L2 based inter-cell mobility candidate cell.
   The neighbor DU then transmits the above information in a third message to the CU. In some embodiments, the third message is a UE Context Setup Response (F1AP message), which can be transmitted in response to the second message, e.g., a UE Context Setup Request, as shown in FIG. 7.

The neighbor DU may determine which of the requested cells are to be configured for L1/L2 inter-cell base mobility. The neighbor DU may have the option to configure a L1/L2 inter-cell mobility candidate which has not been suggested by the CU in the request, and in that case, the DU indicates the configuration(s) for the L1/L2 inter-cell mobility candidate.

In some embodiments, the neighbor DU transmits the third message to the CU even without receiving the second message from the CU. This can occur, for example, when the neighbor DU wants to update an existing configuration of a L1/L2 based inter-cell mobility candidate cell of each neighbor DU or to provide an additional configuration of a L1/L2 based inter-cell mobility candidate cell of each neighbor DU. In these embodiments, the third message can be a UE Context Modification Required (F1AP message) and the CU will reply to this third message with a UE Context Modification Confirm (F1AP message).

In some embodiments, if the neighbor DU does not accept the request for L1/L2 inter-cell mobility, it transmits a UE CONTEXT SETUP RESPONSE message indicating that configuring L1/L2 mobility was not successful with an appropriate cause value.

In various embodiments, the neighbor DU includes in the third message one or more of the following:
a configuration for each candidate SpCell/PCell (i.e., accepted/selected by the DU);
a configuration for each candidate SCell; and
a configuration for each candidate cell group, including a configuration of the L1/L2 inter-cell mobility candidate SpCell and a configuration for the at least one SCell associated with the L1/L2 inter-cell mobility candidate SpCell.

In some embodiments, when the second message includes one or more L1/L2 inter-cell mobility candidates (e.g., encoded in Candidate L1/L2Cell List IE in UE CONTEXT SETUP REQUEST message) and the neighbor DU accepts a subset of these candidates, the neighbor DU indicates in the third message the accepted subset of the cells and possibly additional cells that the neighbor DU added as L1/L2 inter-cell mobility candidates. For example, these cells can be encoded in L1/L2Cell List IE of UE CONTEXT SETUP RESPONSE message. In one option, the gNB-DU shall include the cells in the L1/L2CellList IE in a priority order, where the first cell in the list is the one most desired and the last one is the one least desired.

In some embodiments, when the neighbor DU is unable to establish an F1 UE context or cannot even establish one bearer upon reception of the second message, the neighbor DU shall consider the procedure as failed and reply with a sixth message, e.g., a UE CONTEXT SETUP FAILURE. In some embodiments, the sixth message may include a particular cell identity (e.g., SpCell ID IE) to indicate this is a failure or rejection for a specific cell. In some variants, the DU can include a Potential SpCell List in the UE CONTEXT SETUP FAILURE message, indicating some other candidate cells from which the CU can choose. These cells can be included in a priority order, where the first cell in the list is the one most desired and the last one is the one least desired.

After receiving the one or more third messages, the CU generates an RRC Reconfiguration for configuring the UE with L1/L2 inter-cell mobility, comprising the respective configuration(s) of the L1/L2 based inter-cell mobility candidate cell(s) received from the neighbor DU(s).

In operation 5, the CU transmits to the serving DU a fourth message comprising an RRCReconfiguration message to be transmitted to the UE. The RRCReconfiguration message includes one or more of the following received from the neighbor DU(s):
at least one CSI measurement configuration;
at least one configuration of a L1/L2 based inter-cell mobility candidate cell.
   In some embodiments, the fourth message is a UE Context Modification Request message. In other embodiments, the fourth message is a DL RRC MESSAGE TRANSFER message. In the example shown in FIG. 7, the CU generates the RRCReconfiguration message and encapsulates it in the DL RRC MESSAGE TRANSFER message. The RRCReconfiguration message includes the necessary configurations for the UE to perform L1/L2 inter-cell mobility and related procedures such as CSI measurements and reporting. The RRCReconfiguration message includes the configurations, etc. generated by and received from the one or more neighbor DUs.

In operation 6, the UE's serving DU decapsulates the RRCReconfiguration message generated by the CU and sends it to the UE. The UE applies the configuration(s) comprising the RRCReconfiguration message, after which the UE is configured with at least one L1/L2 inter-cell mobility candidate cell of the neighbor DU, as well as CSI measurements to support L1/L2 inter-cell mobility. At this point, the UE may start CSI measurements on L1/L2 inter-cell mobility candidates received in operation 6 and send CSI reports to the serving DU.

In operations 7-8, the UE sends RRCReconfigurationComplete message to the serving DU, which encapsulates it into an UL RRC MESSAGE TRANSFER message that is sent to the CU. Subsequently, the serving DU may trigger L1/L2 inter-cell mobility for the UE by transmitting lower layer signalling (e.g., MAC CE, DCI) indicating that the UE should change its serving cell to a candidate cell of the neighbor DU. Upon receiving the lower layer signalling, the UE changes its serving cell and operates according to the configuration of the L1/L2 inter-cell mobility candidate cell of the neighbor DU indicated by the lower layer signalling, wherein the configuration of the L1/L2 inter-cell mobility candidate has been received in Step 6.

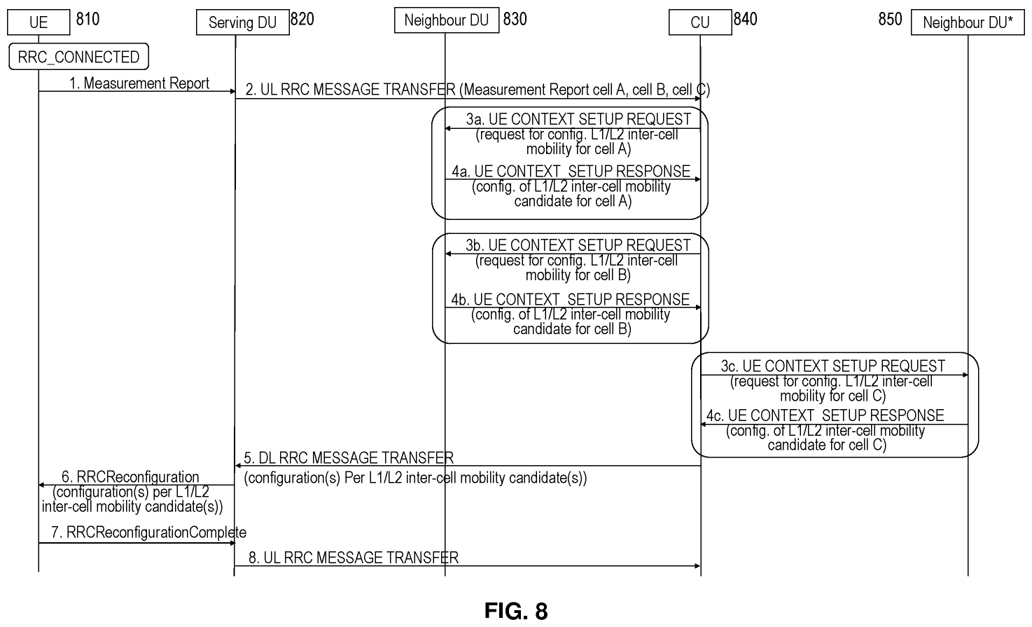

FIG. 8 shows signaling for an exemplary procedure of a CU configuring the UE with L1/L2 inter-cell mobility candidates from two different neighbor DUs, according to some embodiments of the present disclosure. In particular, this exemplary procedure involves one setup procedure per candidate cell.

In operations 1-2, the CU (840) receives a Measurement Report from the UE (810) via the serving DU (820), including one or more measurements of cells A-C. The CU determines that cells A and B are cells of a first neighbor DU (830) and cell C is of a second neighbor DU (850, also denoted DU*).

In operations 3a-4a, the CU sends a first UE CONTEXT SETUP REQUEST message to request the neighbor DU to configure the UE with L1/L2 inter-cell mobility for cell A, and receives a first UE CONTEXT SETUP RESPONSE message including the configuration of cell A, to be applied by the UE upon receiving lower layer signaling to perform L1/L2 inter-cell mobility to cell A. In operations 3b-4b, the CU sends a second UE CONTEXT SETUP REQUEST message to request the neighbor DU to configure the UE with L1/L2 inter-cell mobility for cell B, and receives a second UE CONTEXT SETUP RESPONSE message including the configuration of cell B, to be applied by the UE upon receiving lower layer signaling to perform L1/L2 inter-cell mobility to cell B.

In operations 3c-4c, the CU sends a third UE CONTEXT SETUP REQUEST message to request neighbor DU* to configure the UE with L1/L2 inter-cell mobility for cell C, and receives a third UE CONTEXT SETUP RESPONSE message including the configuration of cell C, to be applied by the UE upon receiving lower layer signaling to perform L1/L2 inter-cell mobility to cell C. For example, each of the configurations for cells A-C can be a CellGroupConfig IE, e.g., CellGroupConfig(A), CellGroupConfig(B), CellGroupConfig(C).

After the CU receives the configurations for the L1/L2 inter-cell mobility candidate cells A, B and C, the CU generates the RRCReconfiguration message to be sent to the UE, including CellGroupConfig(A), CellGroupConfig(B), CellGroupConfig(C). Operations 5-8 are similar to operations 5-8 shown in FIG. 7. If after being configured with these candidates (operation 6), the UE receives a lower layer signaling indication L1/L2 inter-cell mobility to cell A, the UE applies the CellGroupConfig(A) and starts to operate in cell A.

Alternately, the CU can generate an RRCReconfiguration message containing only one configuration for an L1/L2 inter-cell mobility candidate cell, e.g., CellGroupConfig(A), CellGroupConfig(B), or CellGroupConfig(C). The CU can select among the candidates based on some priority criteria provided by the CU and/or the respective DUs.

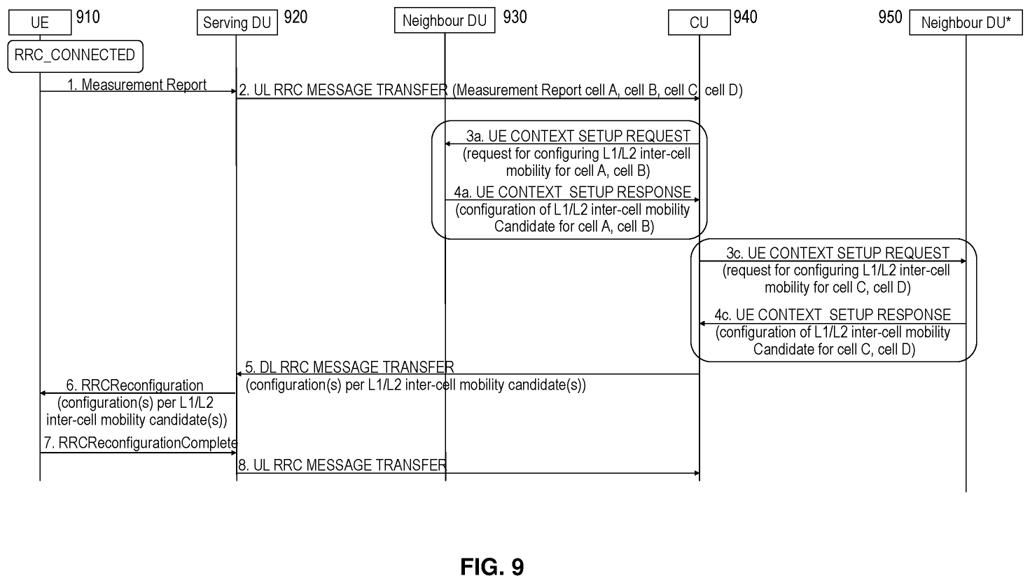

FIG. 9 shows signaling for another exemplary procedure of a CU configuring the UE with L1/L2 inter-cell mobility candidates from two different neighbor DUs, according to other embodiments of the present disclosure. In particular, this exemplary procedure involves one setup procedure per neighbor DU, i.e., for multiple candidate cells.

In operations 1-2, the CU (940) receives a Measurement Report from the UE (910) via the serving DU (920), including one or more measurements of cells A-D. The CU determines that cells A/B are served by a first neighbor DU (930) and cells C/D are served by a second neighbor DU (950, also denoted DU*).

In operations 3a-4a, the CU sends a first UE CONTEXT SETUP REQUEST message to request the neighbor DU to configure the UE with L1/L2 inter-cell mobility for cells A and B, and receives a first UE CONTEXT SETUP RESPONSE message including the configurations of cells A and B, to be applied by the UE upon receiving lower layer signaling to perform L1/L2 inter-cell mobility.

In operations 3c-4c, the CU sends a second UE CONTEXT SETUP REQUEST message to request neighbor DU* to configure the UE with L1/L2 inter-cell mobility for cells C-D, and receives a third UE CONTEXT SETUP RESPONSE message including the configurations of cells C-D, to be applied by the UE upon receiving lower layer signaling to perform L1/L2 inter-cell mobility. For example, each configuration for cells A-D can be a CellGroupConfig IE, e.g., CellGroupConfig(A), CellGroupConfig(B), CellGroupConfig(C), CellGroupConfig(D).

After the CU receives the configurations for the L1/L2 inter-cell mobility candidate cells A-D, the CU generates the RRCReconfiguration message to be sent to the UE, including CellGroupConfig(A), CellGroupConfig(B), CellGroupConfig(C), CellGroupConfig(D).

Operations 5-8 are similar to operations 5-8 shown in FIG. 7. If after being configured with these candidates (operation 6), the UE receives a lower layer signaling indication L1/L2 inter-cell mobility to one of these cells, the UE applies the corresponding CellGroupConfig and starts to operate in that cell.

Alternately, the CU can generate an RRCReconfiguration message containing only one configuration for an L1/L2 inter-cell mobility candidate cell, e.g., CellGroupConfig(A), CellGroupConfig(B), CellGroupConfig(C), or CellGroupConfig(D). The CU can select among the candidates based on some priority criteria provided by the CU and/or the respective DUs.

According to embodiments of the present disclosure, inter-DU L1/L2 inter-cell mobility for a UE may be configured by a neighbor DU for at least one L1/L2 inter-cell mobility candidate SpCell (or PCell). Based on lower layer signaling from the UE's source cell (i.e., SpCell provided by source DU), the UE changes its SpCell to a target SpCell of the neighbor DU, which is one of the configured L1/L2 inter-cell mobility candidates. Additionally, the CU will send a message to the neighbor DU that will indicate that the SpCell will be changed.

Additionally or alternately, inter-DU L1/L2 inter-cell mobility for a UE may be configured by a neighbor DU for at least one L1/L2 inter-cell mobility candidate SCell (e.g., of the UE's MCG). Based on lower layer signaling from the UE's source cell (i.e., PCell provided by source DU), the UE changes its currently activated SCell to a target SCell of the neighbor DU, which is one of the configured L1/L2 inter-cell mobility candidates. Additionally, the CU will send a message to the neighbor DU that will indicate that the SCell will be changed.

Additionally or alternately, inter-DU L1/L2 inter-cell mobility for a UE may be configured by a neighbor DU for at least one L1/L2 inter-cell mobility candidate cell group, including one L1/L2 inter-cell mobility candidate SpCell and one or more SCells of the neighbor DU. For example, each configuration can include a CellGroupConfig IE. Based on lower layer signaling from the UE's source cell (i.e., PCell provided by source DU), the UE changes its currently activated cell group (e.g., MCG) to a cell group provided by the neighbor DU, which is one of the configured L1/L2 inter-cell mobility candidate cell groups. Additionally, the CU will send a message to the neighbor DU indicating that the UE's cell group will be changed.

As mentioned above, in some embodiments, the second message from the CU to the neighbor DU may include a set of candidate SpCells for L1/L2 inter-cell mobility and/or a set of candidates SCell(s) for L1/L2 inter-cell mobility. Each set may be encoded as a list or any other data structure defined in RRC signalling. In some embodiments, the set of candidate SpCells can operate at the same or a different frequency (e.g., SSB frequency, subcarrier spacing, etc.) as the UE's current SpCell (e.g., PCell) in the serving DU.

In some embodiments the neighbor DU receives these set of SpCell(s) and generates a cell group configuration (e.g., CellGroupConfig IE) per L1/L2 based inter-cell mobility candidate SpCell. Each cell group configuration includes a configuration for a candidate SpCell and configuration(s) for one or more SCell(s) associated with the candidate SpCell. In some embodiments, the one or more SCell(s) included in a cell group configuration for a candidate SpCell include one (or more) of the SCell(s) indicated by the CU in the UE CONTEXT SETUP REQUEST message. Alternately, the neighbor DU can include in the cell group configuration other SCell(s) than the one or more indicated by the CU in the UE CONTEXT SETUP REQUEST message.

In some embodiments, the set of SCell candidates included in a cell group configuration by the DU can be used for CA. These candidate SCells can be at the same or a different frequency as the UE's current SpCell (e.g., PCell). In some variants, the set of candidate SCells can be indicated by the CU the UE CONTEXT SETUP REQUEST message, e.g., for CA by the UE.

In some embodiments, the neighbor DU receives from the CU a first set of cells corresponding to a set of SpCell candidates for L1/L2 inter-cell mobility and a second set of cells corresponding to a set of SCell candidates for L1/L2 inter-cell mobility. Upon reception, the neighbor DU generates at least one cell group configuration which comprises the SpCell Configuration for at least one of the SpCell candidates, and the SCell configuration for at least one of the SCell candidates.

In some embodiments, the second set of cells can be SCells of the cell group (e.g., MCG) associated with the UE's current PCell. These can be included, for example, in a Candidate SCell To Be Setup List IE.

In some embodiments, the second set of cells can be different than the SCell(s) of the cell group (e.g., MCG) associated with the UE's current PCell, which are included in the SCell To Be Setup List IE. For example, the CU may include the same SCells in both lists, one for the current PCell cell group configuration and another associated with a L1/L2 inter-cell mobility candidate PCell.

In some embodiments, the two sets are sent by the CU and received by the DU as separate sets e.g., in two lists of cells. The DU determines how these SpCell candidates and SCell candidates are grouped or combined in cell group configuration(s). For example, if the first set of cells include SpCell Ids {1, 2} and the second set includes SCell Ids {4, 5}, the DU may generate SpCellConfig(1) for SpCell Id=1, SCellConfig(4) for SCell Id=4, SCellConfig(5) for SCell Id=5, and CellGroupConfig(1) for SpCellConfig(1)+SCellConfig(4)/SCellConfig(5). The DU provides CellGroupConfig(1) to the CU in the UE CONTEXT SETUP RESPONSE.

In some embodiments, the neighbor DU receives from the CU a set of cell group(s), each including one recommended candidate SpCell for L1/L2 inter-cell mobility and at least one candidate SCell for L1/L2 inter-cell mobility. Upon reception, the neighbor DU generates at least one cell group configuration that includes an SpCell configuration for the SpCell candidate and at least one SCell configuration for the at least one SCell candidate. In this option, the CU requests a specific cell group as a candidate cell group, including both the PCell and one or more SCell(s), while the DU determines to accept or not a cell group being requested by the CU.

In some embodiments, the UE CONTEXT MODIFICATION REQUEST message can include an IE or field (e.g., the Candidate L1/L2Cell List IE) indicating one or more L1/L2 inter-cell mobility candidate cells that are being requested, suggested, or recommended by the CU to the DU. These cells can be identified in different ways, as described below.

In some of these embodiments, this IE or field can include a cell identifier for each L1/L2 inter-cell mobility candidate cell. In some variants, the cell identifier is a Global Cell Identity, e.g., NR CGI(s), PCI and associated frequency, PLMN Identity and associated NR Cell Identity, etc.

In some of these embodiments, this IE or field can include an extended version of the Candidate SpCell List IE (defined in 3GPP TS 38.473), and may have more values, e.g., 0, 1, 2, 3 . . . K. When this arrangement is used, the first value in the list can be the UE's current SpCell (e.g., PCell) while the other values in the list are the L1/L2 inter-cell mobility candidate SpCell(s).

In other of these embodiments, this IE or field can include a cell index for each L1/L2 inter-cell mobility candidate cell, encoded with fewer bits than the cell identifier. In some variants, the cell index can be an integer. The index be used to refer to a particular cell during communication between the UE and/or the CU and/or the DU, e.g., by exchanging a reduced number of bits. In some cases, there may be more L1/L2 inter-cell mobility candidates overall than L1/L2 inter-cell mobility candidates the UE may be configured with.

In other of these embodiments, this IE or field can include a cell group index or identifier for each L1/L2 inter-cell mobility candidate cell and/or L1/L2 inter-cell mobility candidate cell group.

In some of these embodiments, this IE or field can include frequency information for each L1/L2 inter-cell mobility candidate cell. In different variants, the frequency information can include one or more of the following:
an indication of a serving measurement object (e.g., servingCellMO IE as defined in 3GPP TS 38.331) or serving frequency associated a measurement object (MO) of the serving frequency that is also used by the L1/L2 inter-cell mobility candidate; and
an SSB frequency, a CSI-RS frequency, or a point-A frequency, any of which can be encoded as an absolute frequency information (e.g., ARFCN as defined in 3GPP TS 38.331)

In some embodiments, the neighbor DU may initiate the configuration of L1/L2 inter-cell mobility candidate cells in the following cases: 1) an L1/L2 inter-cell mobility candidate cell already configured at the UE needs to be modified or 2) additional L1/L2 inter-cell mobility candidate cells should be configured at the UE. In such cases, the neighbor DU sends a configuration for a L1/L2 inter-cell mobility candidate cell according to the embodiments described above and includes an implicit or explicit indication whether this L1/L2 inter-cell mobility candidate should modify a list of L1/L2 inter-cell mobility candidate cells already configured at the UE or should be added to a list of L1/L2 inter-cell mobility candidate cells already configured at the UE.

In some embodiments, if the neighbor DU initiates the configuration for a L1/L2 inter-cell mobility candidate cell, the UE CONTEXT MODIFICATION REQUIRED message includes an IE or field (e.g., Candidate L1/L2Cell List IE) indicating one or more L1/L2 inter-cell mobility candidate cells which are being configured by the DU to the CU. In this case, the CU may reply with a UE CONTEXT MODIFICATION CONFIRM if accepts the L1/L2 inter-cell mobility candidate cell(s) configured by the neighbor DU or with a UE CONTEXT MODIFICATION REFUSE if it refuses L1/L2 inter-cell mobility candidate cell(s) configured by the neighbor DU.

The following provides some example 3GPP specification text relating to configuration of L1/L2 inter-cell mobility for at least one L1/L2 inter-cell mobility candidate SpCell provided by a neighbor DU, according to some embodiments of the present disclosure.

***Begin example 3GPP specification text***

### 8.3.1 UE Context Setup

### 8.3.1.1 General

[ . . . ]
If the Inter-DU Candidate L1/L2Cell List IE is included in the UE CONTEXT SETUP REQUEST message, the gNB-DU shall consider that these cells are candidate cells recommended for inter-DU L1/L2 inter-cell mobility and will take them under consideration. The recommended cells may correspond to requested cell or suggested cells.
If the Inter-DU L1/L2Cell List IE is included in the UE CONTEXT SETUP RESPONSE message the gNB-CU will understand that the cells are configured for inter-DU L1/L2 mobility. The gNB-DU shall include the cells in the Inter-DU L1/L2Cell List IE in a priority order, where the first cell in the list is the one most desired and the last one is the one least desired (e.g., based on measurements, load conditions
If the L1/L2 Inter-DU Mobility Information IE is included in the UE CONTEXT SETUP REQUEST message, the gNB-DU shall consider that the request concerns a L1/L2 mobility change for the included SpCell ID IE and shall include it as the Requested L1/L2 Target Cell ID IE in the UE CONTEXT SETUP RESPONSE message.
[ . . . ]

### 8.3.1.3 Unsuccessful Operation

[ . . . ]
If the L1/L2l Inter-DU Mobility Information IE was included in the UE CONTEXT SETUP REQUEST message, the gNB-DU shall include the received SpCell ID IE as the L1/L2 Requested Target Cell ID IE in the UE CONTEXT SETUP FAILURE message.
Further, if the Candidate L1/L2 SpCell List IE is included in the UE CONTEXT SETUP REQUEST message and the gNB-DU is not able to accept the SpCell ID IE, the gNB-DU shall, if supported, include the Potential L1/L2 SpCell List IE in the UE CONTEXT SETUP FAILURE message and the gNB-CU should take this into account for selection of an opportune SpCell. The gNB-DU shall include the cells in the Potential L1/L2 SpCell List IE in a priority order, where the first cell in the list is the one most desired and the last one is the one least desired. If the Potential L1/L2 SpCell List IE is present but no Potential L1/L2 SpCell Item E is present, the gNB-CU should assume that none of the cells in the Candidate L1/L2 SpCell List IE are acceptable for the gNB-DU.

### 9.2.2.1 UE CONTEXT SETUP REQUEST

This message is sent by the gNB-CU to request the setup of a E context.

| | | | | | Assigned |
|---|---|---|---|---|---|
| IE/Group Name | Pres. | Range | IE type/ref. | Criticality | Criticality |
| [ . . . ] | [ . . . ] | [ . . . ] | [ . . . ] | [ . . . ] | [ . . . ] |
| INTER-DU Candidate | | 0 . . . 1 | | YES | ignore |
| L1/L2Cell List | | | | | |
| >Inter-DU Candidate | | 1 . . . | | EACH | ignore |
| L1/L2Cell Item IEs | | <maxnoofL1/ | | | |
| | | L2Cells> | | | |
| >>Inter-DU Candidate | M | | NR CGI | — | |
| L1/L2Cell ID | | | 9.3.1.12 | | |
| L1/L2 Inter-DU Mobility | O | | | | |
| Information (Placeholder) | | | | | |

| Range bound | Explanation |
|---|---|
| [ . . . ] | [ . . . ] |
| MaxnoofL1/L2Cells | Maximum no. of Cells configured for L1/L2 mobility |
| | allowed towards one UE, the maximum value is FFS. |

### 9.2.2.2 UE CONTEXT SETUP RESPONSE

This message is sent by the gNB-DU to confirm the setup of a UE context.
Direction: gNB-DU→gNB-CU.

| | | | IE | | Assigned |
|---|---|---|---|---|---|
| IE/Group Name | Pres. | Range | type/ref. | Criticality | Criticality |
| [ . . . ] | [ . . . ] | [ . . . ] | [ . . . ] | [ . . . ] | [ . . . ] |
| Inter-DU L1/L2Cell List | | 0 . . . 1 | | YES | ignore |
| >Inter-DU L1/L2Cell | | 1 . . . | | EACH | ignore |
| Item IEs | | <maxnoofL1/ | | | |
| | | L2Cells> | | | |
| >>Inter-DU L1/L2Cell ID | M | | NR CGI | — | |
| | | | 9.3.1.12 | | |

| Range bound | Explanation |
|---|---|
| [ . . . ] | [ . . . ] |
| MaxnoofL1/L2Cells | Maximum no. of Cells configured for L1/L2 mobility |
| | allowed towards one UE, the maximum value is FFS. |

[ . . . ]

### 9.3.1.26 DU to CU RRC Information

This IE contains the RRC Information that are sent from the gNB-DU to the gNB-CU.

| | | | IE | Semantics | | Assigned |
|---|---|---|---|---|---|---|
| IE/Group Name | Pres. | Range | type/ref. | description | Critical. | Critical. |
| CellGroupConfig | M | | OCTET | CellGroupConfig, | | |
| | | | STRING | as defined in TS | | |
| | | | | 38.331 [8]. | | |
| [. . .] | [. . .] | [. . .] | [. . .] | [. . .] | [. . .] | [. . .] |
| L1/L2 | | 0 . . . 1 | | | YES | ignore |
| CellGroupConfig | | | | | | |
| List | | | | | | |
| >L1/L2 | | 1 . . . | | | EACH | ignore |
| CellGroupConfig | | <maxnoofL1/ | | | | |
| Item IEs | | L2Cells> | | | | |
| >>L1/L2 | M | | OCTET | CellGroupConfig | — | |
| CellGroupConfig | | | STRING | for L1/L2 | | |
| | | | | mobility cells, as | | |
| | | | | defined in TS | | |
| | | | | 38.331 [8]. | | |

| Range bound | Explanation |
|---|---|
| MaxnoofL1/ | Maximum no. of Cells configured for L1/L2 mobility |
| L2Cells | allowed towards one UE, the maximum value is FFS. |

*** End example 3GPP specification text ***

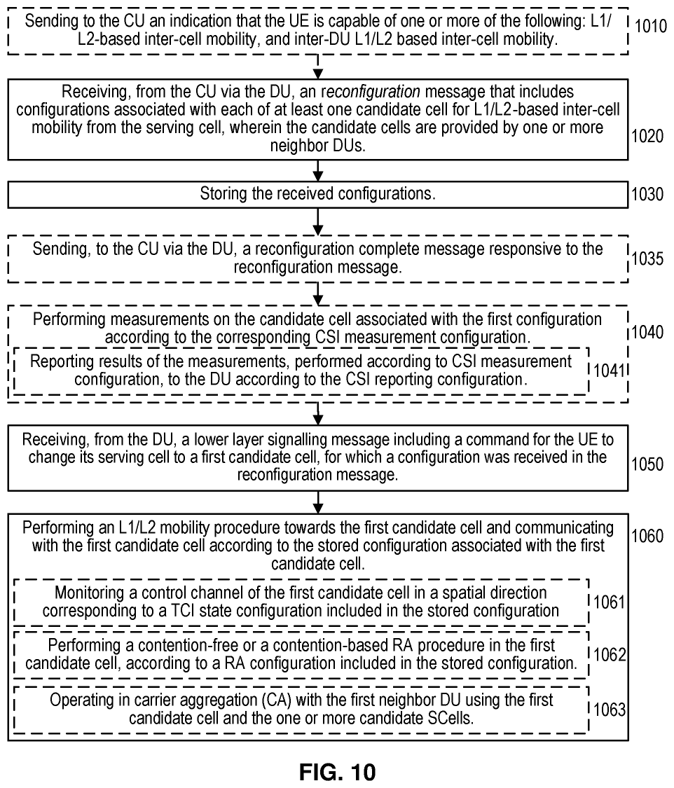

The embodiments described above can be further illustrated with reference to FIGS. 10-12, which depict exemplary methods (e.g., procedures) for a UE, a CU, and a DU, respectively. Put differently, various features of the operations described below correspond to various embodiments described above. The exemplary methods shown in FIGS. 10-12 can be used cooperatively to provide benefits, advantages, and/or solutions to problems described herein. Although the exemplary methods are illustrated in FIGS. 10-12 by specific blocks in particular orders, the operations corresponding to the blocks can be performed in different orders than shown and can be combined and/or divided into blocks and/or operations having different functionality than shown. Optional blocks or operations are indicated by dashed lines.

More specifically, FIG. 10 illustrates an exemplary method (e.g., procedure) for a UE configured to communicate with a RAN node comprising a CU and a DU, according to various embodiments of the present disclosure. The exemplary method shown in FIG. 10 can be performed by a UE (e.g., wireless device) such as described elsewhere herein.

The exemplary method can include the operations of block 1020, where the UE can receive, from the CU via the DU, a reconfiguration message (e.g., RRCReconfiguration) that includes configurations associated with each of at least one candidate cell for L1/L2-based inter-cell mobility from the serving cell, wherein the candidate cells are provided by one or more neighbor DUs. The exemplary method can also include the operations of block 1030, where the UE can store the received configurations. The exemplary method can also include the operations of block 1050, where the UE can receive, from the DU, a lower layer signalling message including a command for the UE to change its serving cell to a first candidate cell, for which a configuration was received in the reconfiguration message. The exemplary method can also include the operations of block 1060, where the UE can perform an L1/L2 mobility procedure towards the first candidate cell and communicate in the first candidate cell according to the stored configuration associated with the first candidate cell.

In some embodiments, the one or more neighbor DUs are associated with the CU and/or are part of the RAN node.

In some embodiments, a first one of the configurations includes a corresponding CSI measurement configuration in the reconfiguration message. In such case, the exemplary method can also include the operations of block 1040, where the UE can perform measurements on the candidate cell associated with the first configuration according to the corresponding CSI measurement configuration. In some of these embodiments, the CSI measurement configuration includes a CSI reporting configuration and performing the measurements in block 1040 includes the operations of sub-block 1041, where the UE can report results of the measurements, performed according to CSI measurement configuration, to the DU according to the CSI reporting configuration.

In some embodiments, the exemplary method can also include the operations of block 1035, where the UE can send, to the CU via the DU, a reconfiguration complete message (e.g., RRCReconfigurationComplete) responsive to the reconfiguration message.

In some embodiments, one or more of the following applies: the lower layer signaling is at a protocol layer lower than an RRC protocol layer; and the lower layer signaling includes one of the following: MAC CE, or PHY Downlink Control Information (DCI).

In some embodiments, communicating in the first candidate cell according to the stored configuration in block 1060 includes one or more of the following operations, denoted by corresponding sub-block numbers:
(1061) monitoring a control channel of the first candidate cell in a spatial direction corresponding to a Transmission Configuration Information (TCI) state configuration included in the stored configuration; and
1062) performing a contention-free or a contention-based random access (RA) procedure in the first candidate cell, according to a RA configuration included in the stored configuration.

In some embodiments, one or more of the following applies:
the UE receives the reconfiguration message during the UE's initial access to the serving DU; and
the reconfiguration message is the initial reconfiguration message received after security is activated during the UE's initial access.

In other embodiments, one or more of the following applies:
the UE receives the reconfiguration message when the UE is in RRC_CONNECTED state with the RAN; and
the UE receives the reconfiguration message in response to an RRC Measurement Report sent by the UE.

In some embodiments, the first candidate cell is a PCell or an SpCell of a cell group provided by a first neighbor DU, and the configuration associated with the first candidate cell includes a configuration for the first candidate cell and configurations for one or more SCells of the cell group. In such embodiments, communicating in the first candidate cell according to the stored configuration ion block 1060 includes the operations of sub-block 1063, where the UE can operate in CA with the first neighbor DU using the first candidate cell and the one or more candidate SCells.

In some of these embodiments, the exemplary method can also include the operations of block 1010, where the UE can send to the CU an indication that the UE is capable of one or more of the following: L1/L2-based inter-cell mobility, and inter-DU L1/L2 based inter-cell mobility.

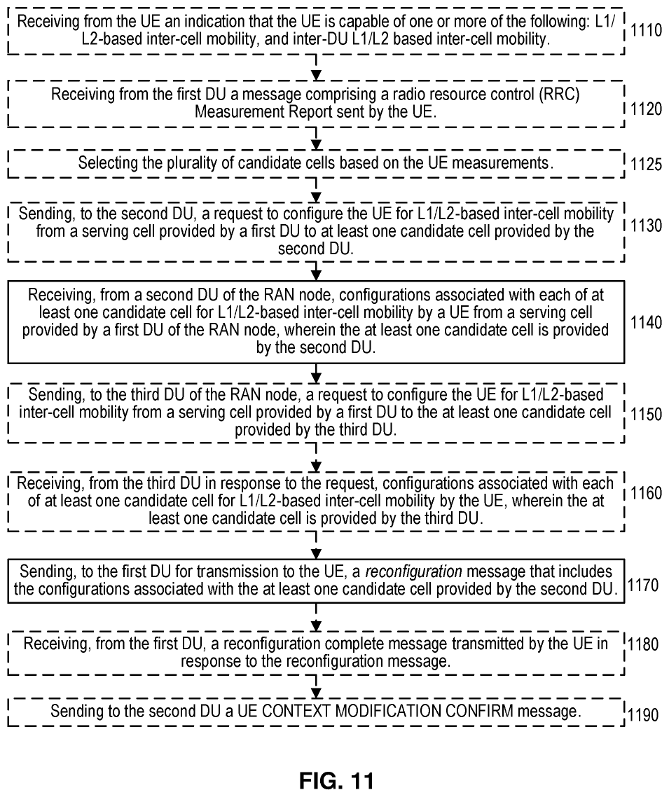

In addition, FIG. 11 illustrates an exemplary method (e.g., procedure) for a CU of a RAN node, according to various embodiments of the present disclosure. The exemplary method shown in FIG. 11 can be performed by a CU such as described elsewhere herein.

The exemplary method can include the operations of block 1140, where the CU can receive, from a second DU of the RAN node, configurations associated with each of at least one candidate cell for L1/L2-based inter-cell mobility by a UE from a serving cell provided by the first DU of the RAN node, wherein the at least one candidate cell is provided by the second DU. The exemplary method can also include the operations of block 1170, where the CU can send, to the first DU for transmission to the UE, a reconfiguration message (e.g., RRCReconfiguration) that includes the configurations associated with the at least one candidate cell provided by the second DU.

In some embodiments, a first one of the configurations includes a corresponding CSI measurement configuration, which is included in the reconfiguration message. In some embodiments, the exemplary method can also include the operations of blocks 1180, where the CU can receive, from the first DU, a reconfiguration complete message (e.g., RRCReconfigurationComplete) transmitted by the UE in response to the reconfiguration message.

In some embodiments, the exemplary method can also include the operations of blocks 1130, where the CU can send, to the second DU, a request to configure the UE for L1/L2-based inter-cell mobility from a serving cell provided by a first DU to at least one candidate cell provided by the second DU. The configurations are received (e.g., in block 1140) in response to the request.

In some of these embodiments, the request to configure the UE is, or is included in, a UE CONTEXT SETUP REQUEST message; the response to the request is, or is included in, a UE CONTEXT SETUP RESPONSE message; and the reconfiguration message is sent to the first DU in one of the following: a DL RRC MESSAGE TRANSFER message, or a UE CONTEXT MODIFICATION REQUEST message.

In some of these embodiments, the exemplary method can also include the operations of blocks 1120, where the CU can receive from the first DU a message comprising an RRC Measurement Report sent by the UE. In some variants, the request to configure the UE for L1/L2-based inter-cell mobility is sent (e.g., in block 1130) in response to the message comprising the RRC Measurement Report. In some variants, the RRC Measurement Report includes one or more UE measurements of the at least one candidate cell provided by the second DU.

In some further variants, the at least one candidate cell includes a plurality of candidate cells, and the exemplary method also includes the operations of block 1125, where the UE can select the plurality of candidate cells based on the UE measurements. In such case, the request sent to the second DU comprises respective identifiers of the plurality of candidate cells.

In other further variants, the request sent to the second DU comprises a plurality of requests corresponding to the plurality of candidate cells, and a plurality of configurations are received in a corresponding plurality of responses. In other further variants, the request sent to the second DU is a single request corresponding to the plurality of candidate cells, and a plurality of configurations are received in a single response.

In some variants, the exemplary method can also include the operations of blocks 1150-1160, where the CU can send to a third DU of the RAN node a request to configure the UE for L1/L2-based inter-cell mobility from a serving cell provided by a first DU to the at least one candidate cell provided by the third DU, and receive from the third DU (e.g., in response to the request) configurations associated with each of at least one candidate cell for L1/L2-based inter-cell mobility, wherein the at least one candidate cell is provided by the third DU.

In some further variants, the at least one candidate cell provided by the third DU comprises a plurality of candidate cells, and one of the following applies:
the request sent to the third DU comprises a plurality of requests corresponding to the plurality of candidate cells, and a plurality of configurations are received in a corresponding plurality of responses; or
the request sent to the third DU is a single request corresponding to the plurality of candidate cells, and a plurality of configurations are received in a single response.

In some further variants, the reconfiguration message (e.g., in block 1170) also includes the configurations associated with the at least one candidate cell provided by the third DU. In some further variants, the RRC Measurement Report includes one or more UE measurements of the at least one candidate cell provided by the third DU.

In some embodiments, the exemplary method can also include the operations of block 1110, where the CU can receive from the UE an indication that the UE is capable of one or more of the following: L1/L2-based inter-cell mobility, and inter-DU L1/L2 based inter-cell mobility. In such embodiments, sending the request to configure the UE (e.g., in block 1130) is based on the indication received from the UE.

In some embodiments, each configuration received from the second DU includes an indication of one of the following: the configuration should be added to configurations previously sent to the UE, or the configuration should replace or modify a configuration previously sent to the UE. In some of these embodiments, the configurations are received from the second DU in a UE CONTEXT MODIFICATION REQUIRED message and the exemplary method also includes the operations of block 1190, where after sending the reconfiguration message (e.g., in block 1170), the UE can send to the second DU a UE CONTEXT MODIFICATION CONFIRM message.

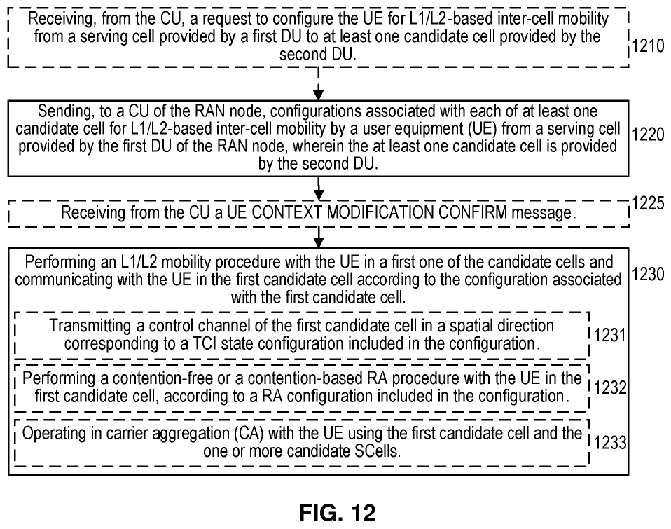

In addition, FIG. 12 illustrates an exemplary method (e.g., procedure) for a DU of a RAN node, according to various embodiments of the present disclosure. The exemplary method shown in FIG. 12 can be performed by DU such as described elsewhere herein.

The exemplary method can include the operations of block 1220, where the DU can send, to a CU of the RAN node, configurations associated with each of at least one candidate cell for L1/L2-based inter-cell mobility by a UE from a serving cell provided by a first DU of the RAN node, wherein the at least one candidate cell is provided by the second DU. The exemplary method can also include the operations of block 1230, where the DU can perform an L1/L2 mobility procedure with the UE in a first one of the candidate cells and communicating with the UE in the first candidate cell according to the configuration associated with the first candidate cell.

In some embodiments, a first one of the configurations includes a corresponding CSI measurement configuration.

In some embodiments, the exemplary method can also include the operations of block 1210, where the DU can receive from the CU a request to configure the UE for L1/L2-based inter-cell mobility from a serving cell provided by a first DU to at least one candidate cell provided by the second DU. In such embodiments, the configurations are sent (e.g., in block 1220) in response to the request. In some of these embodiments, the request to configure the UE is, or is included in, a UE CONTEXT SETUP REQUEST message and the response to the request is, or is included in, a UE CONTEXT SETUP RESPONSE message.

In some of these embodiments, the at least one candidate cell includes a plurality of candidate cells and the request received from the CU comprises respective identifiers of the plurality of candidate cells.

In some of these embodiments, the request received from the CU comprises a plurality of requests corresponding to the plurality of candidate cells, and a plurality of configurations are sent in a corresponding plurality of responses. In other of these embodiments, the request received from the CU is a single request corresponding to the plurality of candidate cells, and a plurality of configurations are sent in a single response.

In other embodiments, each configuration sent to the CU includes an indication of one of the following: the configuration should be added to configurations previously sent to the UE, or the configuration should replace or modify a configuration previously sent to the UE. In some of these embodiments, the configurations are sent to the CU in a UE CONTEXT MODIFICATION REQUIRED message and the exemplary method also includes the operations of block 1225, where the DU can receive from the CU a UE CONTEXT MODIFICATION CONFIRM message.

In some embodiments, communicating with the UE in the first candidate cell according to the configuration in block 1230 includes one or more of the following operations, labelled with corresponding sub-block numbers:
(1231) transmitting a control channel of the first candidate cell in a spatial direction corresponding to a TCI state configuration included in the configuration; and
(1232) performing a contention-free or a contention-based RA procedure with the UE in the first candidate cell, according to a RA configuration included in the configuration.

In other embodiments, the first candidate cell is a PCell or an SpCell of a cell group provided by the second DU, and the configuration associated with the first candidate cell includes a configuration for the first candidate cell and configurations for one or more SCells of the cell group. In such embodiments, communicating with the UE in the first candidate cell according to the configuration in block 1230 includes the operations of sub-block 1233, where the DU can operate in CA with the UE using the first candidate cell and the one or more candidate SCells.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

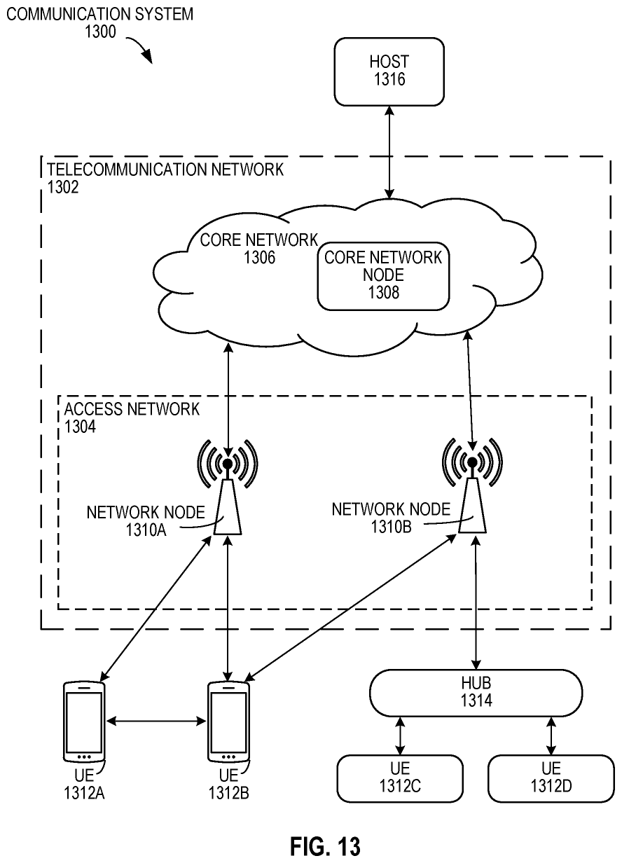

FIG. 13 shows an example of a communication system 1300 in accordance with some embodiments. In this example, communication system 1300 includes a telecommunication network 1302 that includes an access network 1304 (e.g., RAN) and a core network 1306, which includes one or more core network nodes 1308. Access network 1304 includes one or more access network nodes, such as network nodes 1310a-b (one or more of which may be generally referred to as network nodes 1310), or any other similar 3GPP access node or non-3GPP access point. Network nodes 1310 facilitate direct or indirect connection of UEs, such as by connecting UEs 1312a-d (one or more of which may be generally referred to as UEs 1312) to core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1300 may include any number of wired or wireless networks, network nodes, UEs, and/or any other components or systems that may facilitate or participate in the communication of data and/or signals whether via wired or wireless connections. Communication system 1300 may include and/or interface with any type of communication, telecommunication, data, cellular, radio network, and/or other similar type of system.

UEs 1312 may be any of a wide variety of communication devices, including wireless devices arranged, configured, and/or operable to communicate wirelessly with network nodes 1310 and other communication devices. Similarly, network nodes 1310 are arranged, capable, configured, and/or operable to communicate directly or indirectly with UEs 1312 and/or with other network nodes or equipment in telecommunication network 1302 to enable and/or provide network access, such as wireless network access, and/or to perform other functions, such as administration in telecommunication network 1302.

In the depicted example, core network 1306 connects network nodes 1310 to one or more hosts, such as host 1316. These connections may be direct or indirect via one or more intermediary networks or devices. In other examples, network nodes may be directly coupled to hosts. Core network 1306 includes one or more core network nodes (e.g., 1308) that are structured with hardware and software components. Features of these components may be substantially similar to those described with respect to the UEs, network nodes, and/or hosts, such that the descriptions thereof are generally applicable to the corresponding components of core network node 1308.

Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1316 may be under the ownership or control of a service provider other than an operator or provider of access network 1304 and/or telecommunication network 1302, and may be operated by the service provider or on behalf of the service provider. Host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1302 is a cellular network that implements 3GPP standardized features. Accordingly, telecommunication network 1302 may support network slicing to provide different logical networks to different devices that are connected to telecommunication network 1302. For example, telecommunication network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1312 are configured to transmit and/or receive information without direct human interaction. For instance, a UE may be designed to transmit information to access network 1304 on a predetermined schedule, when triggered by an internal or external event, or in response to requests from access network 1304. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, hub 1314 communicates with access network 1304 to facilitate indirect communication between one or more UEs (e.g., UE 1312c and/or 1312d) and network nodes (e.g., network node 1310b). In some examples, hub 1314 may be a controller, router, content source and analytics, or any of the other communication devices described herein regarding UEs. For example, hub 1314 may be a broadband router enabling access to core network 1306 for the UEs. As another example, hub 1314 may be a controller that sends commands or instructions to one or more actuators in the UEs. Commands or instructions may be received from the UEs, network nodes 1310, or by executable code, script, process, or other instructions in hub 1314. As another example, hub 1314 may be a data collector that acts as temporary storage for UE data and, in some embodiments, may perform analysis or other processing of the data. As another example, hub 1314 may be a content source. For example, for a UE that is a VR headset, display, loudspeaker or other media delivery device, hub 1314 may retrieve VR assets, video, audio, or other media or data related to sensory information via a network node, which hub 1314 then provides to the UE either directly, after performing local processing, and/or after adding additional local content. In still another example, hub 1314 acts as a proxy server or orchestrator for the UEs, in particular in if one or more of the UEs are low energy IoT devices.

Hub 1314 may have a constant/persistent or intermittent connection to network node 1310b. Hub 1314 may also allow for a different communication scheme and/or schedule between hub 1314 and UEs (e.g., UE 1312c and/or 1312d), and between hub 1314 and core network 1306. In other examples, hub 1314 is connected to core network 1306 and/or one or more UEs via a wired connection. Moreover, hub 1314 may be configured to connect to an M2M service provider over access network 1304 and/or to another UE over a direct connection. In some scenarios, UEs may establish a wireless connection with network nodes 1310 while still connected via hub 1314 via a wired or wireless connection. In some embodiments, hub 1314 may be a dedicated hub—that is, a hub whose primary function is to route communications to/from the UEs from/to network node 1310b. In other embodiments, hub 1314 may be a non-dedicated hub—that is, a device which is capable of operating to route communications between the UEs and network node 1310b, but which is additionally capable of operating as a communication start and/or end point for certain data channels.

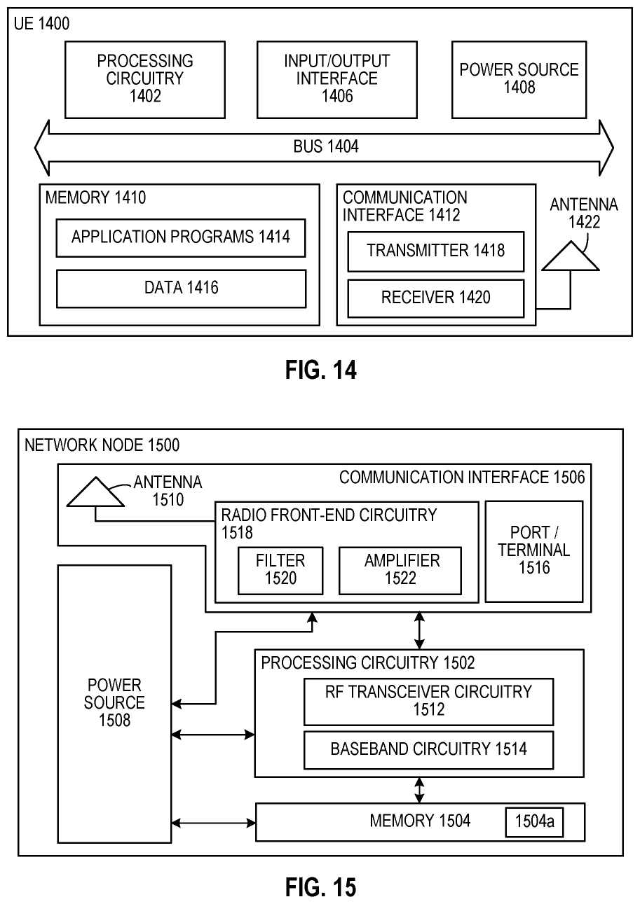

FIG. 14 shows a UE 1400 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1400 includes processing circuitry 1402 that is operatively coupled via bus 1404 to input/output interface 1406, power source 1408, memory 1410, communication interface 1412, and/or one or more other components. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

Processing circuitry 1402 is configured to process instructions and data and may be configured to implement any sequential state machine operative to execute instructions stored as machine-readable computer programs in memory 1410. Processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1402 may include multiple central processing units (CPUs).

In the example, input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1408 is structured as a battery or battery pack. Other types of power sources, such as an external power source (e.g., an electricity outlet), photovoltaic device, or power cell, may be used. Power source 1408 may further include power circuitry for delivering power from power source 1408 itself, and/or an external power source, to the various parts of UE 1400 via input circuitry or an interface such as an electrical power cable. Delivering power may be, for example, for charging of power source 1408. Power circuitry may perform any formatting, converting, or other modification to the power from power source 1408 to make the power suitable for the respective components of UE 1400 to which power is supplied.

Memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1410 includes one or more application programs 1414, such as an operating system, web browser application, a widget, gadget engine, or other application, and corresponding data 1416. Memory 1410 may store, for use by UE 1400, any of a variety of various operating systems or combinations of operating systems.

Memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1410 may allow UE 1400 to access instructions, application programs and the like, stored on transitory or non-transitory memory media, to off-load data, or to upload data. An article of manufacture, such as one utilizing a communication system may be tangibly embodied as or in memory 1410, which may be or comprise a device-readable storage medium.

Processing circuitry 1402 may be configured to communicate with an access network or other network using communication interface 1412. Communication interface 1412 may comprise one or more communication subsystems and may include or be communicatively coupled to an antenna 1422. Communication interface 1412 may include one or more transceivers used to communicate, such as by communicating with one or more remote transceivers of another device capable of wireless communication (e.g., another UE or a network node in an access network).

Each transceiver may include transmitter 1418 and/or receiver 1420 appropriate to provide network communications (e.g., optical, electrical, frequency allocations, and so forth). Moreover, transmitter 1418 and receiver 1420 may be coupled to one or more antennas (e.g., 1422) and may share circuit components, software or firmware, or alternatively be implemented separately.

In the illustrated embodiment, communication functions of communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1500 includes processing circuitry 1502, memory 1504, communication interface 1506, and power source 1508. Network node 1500 may be composed of multiple physically separate components (e.g., a NodeB component and a RNC component, or a BTS component and a BSC component, etc.), which may each have their own respective components. In certain scenarios in which network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). Network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

Processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as memory 1504, to provide network node 1500 functionality.

In some embodiments, processing circuitry 1502 includes a system on a chip (SOC). In some embodiments, processing circuitry 1502 includes one or more of radio frequency (RF) transceiver circuitry 1512 and baseband processing circuitry 1514. In some embodiments, RF transceiver circuitry 1512 and baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

Memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1502. Memory 1504 may store any suitable instructions, data, or information, including a computer program, software, an application including one or more of logic, rules, code, tables, and/or other instructions (collectively denoted computer program 1504a, which may be in the form of a computer program product) capable of being executed by processing circuitry 1502 and utilized by network node 1500. Memory 1504 may be used to store any calculations made by processing circuitry 1502 and/or any data received via communication interface 1506. In some embodiments, processing circuitry 1502 and memory 1504 is integrated.

Communication interface 1506 is used in wired or wireless communication of signaling and/or data between a network node, access network, and/or UE. As illustrated, communication interface 1506 comprises port(s)/terminal(s) 1516 to send and receive data, for example to and from a network over a wired connection. Communication interface 1506 also includes radio front-end circuitry 1518 that may be coupled to, or in certain embodiments a part of, antenna 1510. Radio front-end circuitry 1518 comprises filters 1520 and amplifiers 1522. Radio front-end circuitry 1518 may be connected to an antenna 1510 and processing circuitry 1502. The radio front-end circuitry may be configured to condition signals communicated between antenna 1510 and processing circuitry 1502. Radio front-end circuitry 1518 may receive digital data that is to be sent out to other network nodes or UEs via a wireless connection. Radio front-end circuitry 1518 may convert the digital data into a radio signal having the appropriate channel and bandwidth parameters using a combination of filters 1520 and/or amplifiers 1522. The radio signal may then be transmitted via antenna 1510. Similarly, when receiving data, antenna 1510 may collect radio signals which are then converted into digital data by radio front-end circuitry 1518. The digital data may be passed to processing circuitry 1502. In other embodiments, the communication interface may comprise different components and/or different combinations of components.

In certain alternative embodiments, network node 1500 does not include separate radio front-end circuitry 1518, instead, processing circuitry 1502 includes radio front-end circuitry and is connected to antenna 1510. Similarly, in some embodiments, all or some of RF transceiver circuitry 1512 is part of communication interface 1506. In still other embodiments, communication interface 1506 includes one or more ports or terminals 1516, radio front-end circuitry 1518, and RF transceiver circuitry 1512, as part of a radio unit (not shown), and communication interface 1506 communicates with baseband processing circuitry 1514, which is part of a digital unit (not shown).

Antenna 1510 may include one or more antennas, or antenna arrays, configured to send and/or receive wireless signals. Antenna 1510 may be coupled to radio front-end circuitry 1518 and may be any type of antenna capable of transmitting and receiving data and/or signals wirelessly. In certain embodiments, antenna 1510 is separate from network node 1500 and connectable to network node 1500 through an interface or port.

Antenna 1510, communication interface 1506, and/or processing circuitry 1502 may be configured to perform any receiving operations and/or certain obtaining operations described herein as being performed by the network node. Any information, data and/or signals may be received from a UE, another network node and/or any other network equipment. Similarly, antenna 1510, communication interface 1506, and/or processing circuitry 1502 may be configured to perform any transmitting operations described herein as being performed by the network node. Any information, data and/or signals may be transmitted to a UE, another network node and/or any other network equipment.

Power source 1508 provides power to the various components of network node 1500 in a form suitable for the respective components (e.g., at a voltage and current level needed for each respective component). Power source 1508 may further comprise, or be coupled to, power management circuitry to supply the components of network node 1500 with power for performing the functionality described herein. For example, network node 1500 may be connectable to an external power source (e.g., the power grid, an electricity outlet) via an input circuitry or interface such as an electrical cable, whereby the external power source supplies power to power circuitry of power source 1508. As a further example, power source 1508 may comprise a source of power in the form of a battery or battery pack which is connected to, or integrated in, power circuitry. The battery may provide backup power should the external power source fail.

Embodiments of network node 1500 may include additional components beyond those shown in FIG. 15 for providing certain aspects of the network node's functionality, including any of the functionality described herein and/or any functionality necessary to support the subject matter described herein. For example, network node 1500 may include user interface equipment to allow input of information into network node 1500 and to allow output of information from network node 1500. This may allow a user to perform diagnostic, maintenance, repair, and other administrative functions for network node 1500.

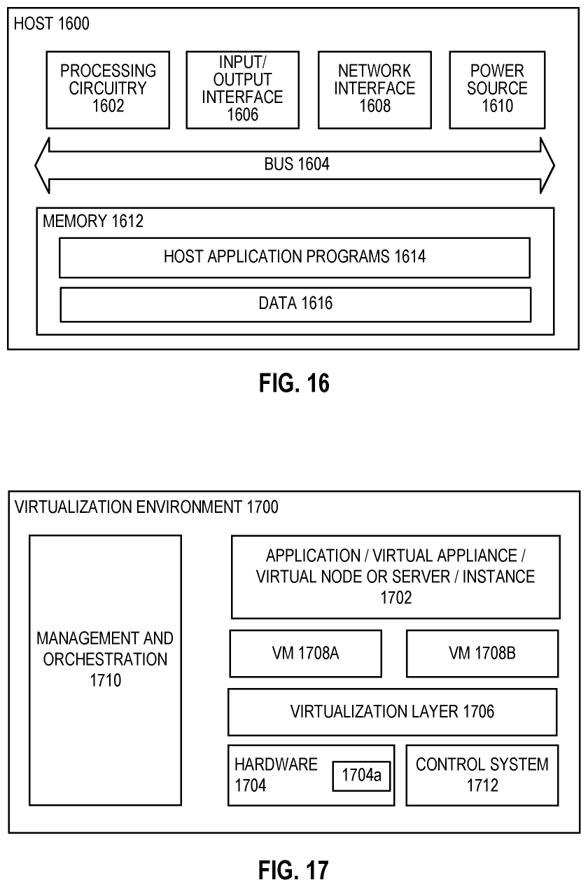

FIG. 16 is a block diagram of a host 1600, which may be an embodiment of host 1316 of FIG. 13, in accordance with various aspects described herein. As used herein, host 1600 may be or comprise various combinations of hardware and/or software, including standalone server, blade server, cloud-implemented server, distributed server, virtual machine, container, or processing resources in a server farm. Host 1600 may provide one or more services to one or more UEs.

Host 1600 includes processing circuitry 1602 that is operatively coupled via bus 1604 to input/output interface 1606, network interface 1608, power source 1610, and memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

Memory 1612 may include one or more computer programs including one or more host application programs 1614 and data 1616, which may include user data, e.g., data generated by a UE for host 1600 or data generated by host 1600 for a UE. Embodiments of host 1600 may utilize only a subset or all of the components shown. Host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1614 may also provide for user authentication and licensing checks and may periodically report health, routes, and content availability to a central node, such as a device in or on the edge of a core network. Accordingly, host 1600 may select and/or indicate a different host for over-the-top services for a UE. Host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. Virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1704 includes processing circuitry, memory that stores software and/or instructions (collectively denoted computer program 1704a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. Virtualization layer 1706 may present a virtual operating platform that appears like networking hardware to VMs 1708.

VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1708 may be a software implementation of a physical machine that runs programs as if they were executing on a physical, non-virtualized machine. Each VM 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of hardware 1704 and corresponds to application 1702.

Hardware 1704 may be implemented in a standalone network node with generic or specific components. Hardware 1704 may implement some functions via virtualization. Alternatively, hardware 1704 may be part of a larger cluster of hardware (e.g., such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

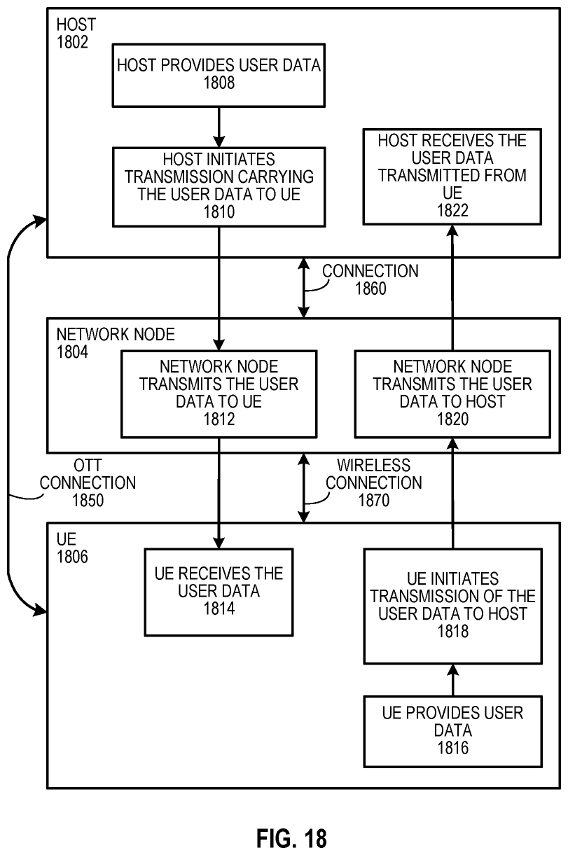

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. Host 1802 also includes software, which is stored in or accessible by host 1802 and executable by the processing circuitry. The software includes a host application that may be operable to provide a service to a remote user, such as UE 1806 connecting via an over-the-top (OTT) connection 1850 extending between UE 1806 and host 1802. In providing the service to the remote user, a host application may provide user data which is transmitted using OTT connection 1850.

Network node 1804 includes hardware enabling it to communicate with host 1802 and UE 1806. Connection 1860 may be direct or pass through a core network (like core network 1306 of FIG. 13) and/or one or more other intermediate networks, such as one or more public, private, or hosted networks. For example, an intermediate network may be a backbone network or the Internet.

UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of host 1802. In host 1802, an executing host application may communicate with the executing client application via OTT connection 1850 terminating at UE 1806 and host 1802. In providing the service to the user, the UE's client application may receive request data from the host's host application and provide user data in response to the request data. OTT connection 1850 may transfer both the request data and the user data. The UE's client application may interact with the user to generate the user data that it provides to the host application through OTT connection 1850.

OTT connection 1850 may extend via a connection 1860 between host 1802 and network node 1804 and via a wireless connection 1870 between network node 1804 and UE 1806 to provide the connection between host 1802 and UE 1806. Connection 1860 and wireless connection 1870, over which OTT connection 1850 may be provided, have been drawn abstractly to illustrate the communication between host 1802 and UE 1806 via network node 1804, without explicit reference to any intermediary devices and the precise routing of messages via these devices.

As an example of transmitting data via OTT connection 1850, in step 1808, host 1802 provides user data, which may be performed by executing a host application. In some embodiments, the user data is associated with a particular human user interacting with UE 1806. In other embodiments, the user data is associated with a UE 1806 that shares data with host 1802 without explicit human interaction. In step 1810, host 1802 initiates a transmission carrying the user data towards UE 1806. Host 1802 may initiate the transmission responsive to a request transmitted by UE 1806. The request may be caused by human interaction with UE 1806 or by operation of the client application executing on UE 1806. The transmission may pass via network node 1804, in accordance with the teachings of the embodiments described throughout this disclosure. Accordingly, in step 1812, network node 1804 transmits to UE 1806 the user data that was carried in the transmission that host 1802 initiated, in accordance with the teachings of the embodiments described throughout this disclosure. In step 1814, UE 1806 receives the user data carried in the transmission, which may be performed by a client application executed on UE 1806 associated with the host application executed by host 1802.

In some examples, UE 1806 executes a client application which provides user data to host 1802. The user data may be provided in reaction or response to the data received from host 1802. Accordingly, in step 1816, UE 1806 may provide user data, which may be performed by executing the client application. In providing the user data, the client application may further consider user input received from the user via an input/output interface of UE 1806. Regardless of the specific manner in which the user data was provided, UE 1806 initiates, in step 1818, transmission of the user data towards host 1802 via network node 1804. In step 1820, in accordance with the teachings of the embodiments described throughout this disclosure, network node 1804 receives user data from UE 1806 and initiates transmission of the received user data towards host 1802. In step 1822, host 1802 receives the user data carried in the transmission initiated by UE 1806.

One or more of the various embodiments improve the performance of OTT services provided to UE 1806 using OTT connection 1850, in which wireless connection 1870 forms the last segment. More precisely, embodiments can facilitate configuring a UE with one or more L1/L2 inter-cell mobility candidate cells associated with a neighbor DU, which allows the UE to move further in its coverage area and still be able to perform/execute L1/L2 inter-cell mobility. This promotes more efficient signaling, reduced processing, and reduced interruption time compared to an L3 (e.g., RRC) handover. Embodiments also maintain L1/L2 mobility interoperability between the UE, the serving DU/CU, and the neighbor DU without ambiguities. By improving the operation of UEs and RANs in this manner, embodiments increase the value of OTT services delivered to/from the UE via the RAN.

In an example scenario, factory status information may be collected and analyzed by host 1802. As another example, host 1802 may process audio and video data which may have been retrieved from a UE for use in creating maps. As another example, host 1802 may collect and analyze real-time data to assist in controlling vehicle congestion (e.g., controlling traffic lights). As another example, host 1802 may store surveillance video uploaded by a UE. As another example, host 1802 may store or control access to media content such as video, audio, VR or AR which it can broadcast, multicast or unicast to UEs. As other examples, host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1850 between host 1802 and UE 1806, in response to variations in the measurement results. The measurement procedure and/or the network functionality for reconfiguring the OTT connection may be implemented in software and hardware of host 1802 and/or UE 1806. In some embodiments, sensors (not shown) may be deployed in or in association with other devices through which OTT connection 1850 passes; the sensors may participate in the measurement procedure by supplying values of the monitored quantities exemplified above, or supplying values of other physical quantities from which software may compute or estimate the monitored quantities. The reconfiguring of OTT connection 1850 may include message format, retransmission settings, preferred routing etc.; the reconfiguring need not directly alter the operation of network node 1804. Such procedures and functionalities may be known and practiced in the art. In certain embodiments, measurements may involve proprietary UE signaling that facilitates measurements of throughput, propagation times, latency and the like, by host 1802. The measurements may be implemented in that software causes messages to be transmitted, in particular empty or ‘dummy’ messages, using OTT connection 1850 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured to communicate with a radio access network (RAN) node comprising a central unit (CU) and a distributed unit (DU) via a serving cell, the method comprising:
   receiving, from the CU via the DU, an RRCReconfiguration message that includes configurations associated with each of at least one candidate cell for L1/L2-based inter-cell mobility from the serving cell, wherein the candidate cells are provided by one or more neighbor DUs;
   storing the received configurations;
   receiving, from the DU, a lower layer signalling message indicating that the UE should change its serving cell to a first candidate cell identified in the RRCReconfiguration message; and
   performing an L1/L2 mobility procedure towards the first candidate cell and communicating in the first candidate cell according to the stored configuration associated with the first candidate cell.
A2. The method of embodiment A1, wherein the one or more neighbor DUs are associated with the CU and/or are part of the RAN node.
A3. The method of any of embodiments A1-A2, wherein:
   a first one of the configurations includes a corresponding Channel State Information (CSI) measurement configuration in the RRCReconfiguration message; and
   the method further comprises performing measurements on the candidate cell associated with the first configuration according to the corresponding CSI measurement configuration.
A4. The method of embodiment A3, wherein:
   the CSI measurement configuration includes a CSI reporting configuration; and performing the measurements includes reporting results of the measurements,
      performed according to CSI measurement configuration, to the DU according to the CSI reporting configuration.
A5. The method of any of embodiments A1-A4, further comprising sending, to the CU via the DU, an RRCReconfigurationComplete message responsive to the RRCReconfiguration message.
A6. The method of any of embodiments A1-A5, wherein one or more of the following applies:
   the lower layer signaling is at a protocol layer below the radio resource control (RRC) protocol layer; and
   the lower layer signaling includes one of the following: MAC Control Element (MAC CE), or PHY Downlink Control Information (DCI).
A7. The method of any of embodiments A1-A6, wherein communicating in the first candidate cell according to the stored configuration includes one or more of the following:
   monitoring a control channel of the first candidate cell in a spatial direction corresponding to a Transmission Configuration Information (TCI) state configuration included in the stored configuration; and
   performing a contention-free or a contention-based random access (RA) procedure in the first candidate cell, according to a RA configuration included in the stored configuration.
A8. The method of any of embodiments A1-A7, wherein one or more of the following applies:
   the UE receives the RRCReconfiguration message during the UE's initial access to the serving DU; and
   the RRCReconfiguration message is the initial RRCReconfiguration message received after security is activated during the UE's initial access.
A9. The method of any of embodiments A1-A7, wherein one or more of the following applies:
   the UE receives the RRCReconfiguration message when the UE is in RRC_CONNECTED state with the RAN; and
   the UE receives the RRCReconfiguration message in response to a radio resource control (RRC) Measurement Report sent by the UE.
A10. The method of any of embodiments A1-A9, wherein:
   the first candidate cell is a primary cell (PCell) or a special cell (SpCell) of a cell group provided by a first neighbor DU;
   the configuration associated with the first candidate cell also includes configurations for one or more secondary cells (SCells) of the cell group; and
   communicating in the first candidate cell according to the stored configuration comprises operating in carrier aggregation (CA) with the first neighbor DU using the first candidate cell and the one or more candidate SCells.
A11. The method of any of embodiments A1-A10, further comprising sending to the CU an indication that the UE is capable of one or more of the following: L1/L2-based inter-cell mobility, and inter-DU L1/L2 based inter-cell mobility.
B1. A method for a central unit (CU), of a radio access network (RAN) node, that is coupled to a plurality of distributed units (DUs) of the RAN node, the method comprising:
   receiving, from a second DU, configurations associated with each of at least one candidate cell for L1/L2-based inter-cell mobility by a user equipment (UE) from a serving cell provided by the first DU, wherein the at least one candidate cell is provided by the second DU; and
   sending, to the first DU for transmission to the UE, an RRCReconfiguration message that includes the configurations associated with the at least one candidate cell provided by the second DU.
B2. The method of embodiment B1, wherein the second DU is associated with the CU and/or is part of the RAN node.
B3. The method of any of embodiments B1-B2, further comprising receiving, from the first DU, an RRCReconfigurationComplete transmitted by the UE in response to the RRCReconfiguration message.
B4. The method of any of embodiments B1-B3, wherein a first one of the configurations includes a corresponding Channel State Information (CSI) measurement configuration, which is included in the RRCReconfiguration message.
B4a. The method of any of embodiments B1-B4, wherein:
   the method further comprises sending, to the second DU, a request to configure the UE for L1/L2-based inter-cell mobility from a serving cell provided by a first DU to at least one candidate cell provided by the second DU; and
   the configurations are received in response to the request.
B5. The method of embodiment B4a, wherein:
   the request to configure the UE is, or is included in, a UE CONTEXT SETUP REQUEST message;
   the response to the request is, or is included in, a UE CONTEXT SETUP RESPONSE message; and
   the RRCReconfiguration message is sent to the first DU in one of the following: a DL RRC MESSAGE TRANSFER message, or a UE CONTEXT MODIFICATION REQUEST message.
B6. The method of any of embodiments B4a-B5, further comprising receiving from the first DU a message comprising a radio resource control (RRC) Measurement Report sent by the UE, wherein the request to configure the UE for L1/L2-based inter-cell mobility is sent in response to the message comprising the RRC Measurement Report.
B6a. The method of embodiment B6, wherein the RRC Measurement Report includes one or more UE measurements of the at least one candidate cell provided by the second DU.
B6b. The method of embodiment B6a, wherein:
   the at least one candidate cell includes a plurality of candidate cells;
   the method further comprises selecting the plurality of candidate cells based on the UE measurements; and
   the request sent to the second DU comprises respective identifiers of the plurality of candidate cells.
B7. The method of any of embodiments B6-B6a, wherein one of the following applies:
   the request sent to the second DU comprises a plurality of requests corresponding to the plurality of candidate cells, and a plurality of configurations are received in a corresponding plurality of responses; or
   the request sent to the second DU is a single request corresponding to the plurality of candidate cells, and a plurality of configurations are received in a single response.
B9. The method of any of embodiments B6-B8, further comprising:
   sending, to a third DU, a request to configure the UE for L1/L2-based inter-cell mobility from a serving cell provided by a first DU to the at least one candidate cell provided by the third DU;
   receiving, from the third DU in response to the request, configurations associated with each of at least one candidate cell for L1/L2-based inter-cell mobility, wherein the at least one candidate cell is provided by the third DU.
B9a. The method of embodiment B9, wherein the RRC Measurement Report includes one or more UE measurements of the at least one candidate cell provided by the third DU.
B9b. The method of any of embodiments B9-B9a, wherein the at least one candidate cell provided by the third DU comprises a plurality of candidate cells, and one of the following applies:
   the request sent to the third DU comprises a plurality of requests corresponding to the plurality of candidate cells, and a plurality of configurations are received in a corresponding plurality of responses; or
   the request sent to the third DU is a single request corresponding to the plurality of candidate cells, and a plurality of configurations are received in a single response.
B10. The method of any of embodiments B9-B9b, wherein the RRCReconfiguration message also includes the configurations associated with the at least one candidate cell provided by the third DU.
B11. The method of any of embodiments B4a-B10, wherein:
   the method further comprises receiving from the UE an indication that the UE is capable of one or more of the following: L1/L2-based inter-cell mobility, and inter-DU L1/L2 based inter-cell mobility; and
   sending the request to configure the UE is based on the indication received from the UE.
B12. The method of any of embodiments B1-B4, wherein each configuration received from the second DU includes an indication of one of the following: the configuration should be added to configurations previously sent to the UE, the configuration should replace or modify a configuration previously sent to the UE.
B13. The method of embodiment B12, wherein:
   the configurations are received from the second DU in a UE CONTEXT MODIFICATION REQUIRED message; and
   the method further comprises, after sending the RRCReconfiguration message, sending to the second DU a UE CONTEXT MODIFICATION CONFIRM message.
C1. A method for a second distributed unit (DU), of a radio access network (RAN) node, that is coupled to a centralized unit (CU) of the RAN node, the method comprising:
   sending, to the CU, configurations associated with each of at least one candidate cell for L1/L2-based inter-cell mobility by a user equipment (UE) from a serving cell provided by the first DU, wherein the at least one candidate cell is provided by the second DU; and
   performing an L1/L2 mobility procedure with the UE in a first one of the candidate cells and communicating with the UE in the first candidate cell according to the configuration associated with the first candidate cell.
C2. The method of embodiment C1, wherein the first DU is associated with the CU and/or is part of the RAN node.
C3. The method of any of embodiments C1-C2, wherein a first one of the configurations includes a corresponding Channel State Information (CSI) measurement configuration.
C4. The method of any of embodiments C1-C3, wherein:
   the method further comprises receiving, from the CU, a request to configure the UE for L1/L2-based inter-cell mobility from a serving cell provided by a first DU to at least one candidate cell provided by the second DU; and
   the configurations are sent in response to the request.
C5. The method of embodiment C4, wherein:
   the request to configure the UE is, or is included in, a UE CONTEXT SETUP REQUEST message; and
   the response to the request is, or is included in, a UE CONTEXT SETUP RESPONSE message.
C6. The method of any of embodiments C4-C5, wherein:
   the at least one candidate cell includes a plurality of candidate cells; and
   the request received from the CU comprises respective identifiers of the plurality of candidate cells.
C7. The method of any of embodiments C4-C6, wherein one of the following applies:
   the request received from the CU comprises a plurality of requests corresponding to the plurality of candidate cells, and a plurality of configurations are sent in a corresponding plurality of responses; or
   the request received from the CU is a single request corresponding to the plurality of candidate cells, and a plurality of configurations are sent in a single response.
C8. The method of any of embodiments C1-C3, wherein each configuration sent to the CU includes an indication of one of the following: the configuration should be added to configurations previously sent to the UE, the configuration should replace or modify a configuration previously sent to the UE.
C9. The method of embodiment C8, wherein:
   the configurations are sent to the CU in a UE CONTEXT MODIFICATION REQUIRED message; and
   the method further comprises receiving from the CU a UE CONTEXT MODIFICATION CONFIRM message.
C10. The method of any of embodiments C1-C9, wherein communicating with the UE in the first candidate cell according to the configuration includes one or more of the following:
   transmitting a control channel of the first candidate cell in a spatial direction corresponding to a Transmission Configuration Information (TCI) state configuration included in the configuration; and
   performing a contention-free or a contention-based random access (RA) procedure with the UE in the first candidate cell, according to a RA configuration included in the configuration.
C11. The method of any of embodiments C1-C9, wherein:
   the first candidate cell is a primary cell (PCell) or a special cell (SpCell) of a cell group provided by the second DU;
   the configuration associated with the first candidate cell also includes configurations for one or more secondary cells (SCells) provided by the second DU; and
   communicating with the UE in the first candidate cell according to the configuration comprises operating in carrier aggregation (CA) with the UE using the first candidate cell and the one or more candidate SCells.
D1. A user equipment (UE) configured to communicate with a radio access network (RAN) node comprising a central unit (CU) and a distributed unit (DU) via a serving cell, the UE comprising:
   communication interface circuitry configured to communicate with the CU and at least the DU; and
   processing circuitry operably coupled to the communication interface circuitry, wherein the processing circuitry and communication interface circuitry are further configured to perform operations corresponding to any of the methods of embodiments A1-A11.
D2. A user equipment (UE) configured to communicate with a radio access network (RAN) node comprising a central unit (CU) and a distributed unit (DU) via a serving cell, the UE being further configured to perform operations corresponding to any of the methods of embodiments A1-A11.
D3. A non-transitory, computer-readable medium storing computer-executable instructions that, when executed by processing circuitry of a user equipment (UE) configured to communicate with a radio access network (RAN) node comprising a central unit (CU) and a distributed unit (DU) via a serving cell, configure the UE to perform operations corresponding to any of the methods of embodiments A1-A11.
D4. A computer program product comprising computer-executable instructions that, when executed by processing circuitry of a user equipment (UE) configured to communicate with a radio access network (RAN) node comprising a central unit (CU) and a distributed unit (DU) via a serving cell, configure the UE to perform operations corresponding to any of the methods of embodiments A1-A11.
E1. A central unit (CU), of a radio access network (RAN) node, that is coupled to a plurality of distributed units (DUs) of the RAN node, the CU comprising:
   communication interface circuitry configured to communicate with the DUs and with one or more UEs via cells provided by the DUs; and
   processing circuitry operably coupled to the communication interface circuitry, whereby the processing circuitry and the communication interface circuitry are configured to perform operations corresponding to any of the methods of embodiments B1-B13.
E2. A central unit (CU), of a radio access network (RAN) node, that is coupled to a plurality of distributed units (DUs) of the RAN node, the CU being configured to perform operations corresponding to any of the methods of embodiments B1-B13.
E3. A non-transitory, computer-readable medium storing computer-executable instructions that, when executed by processing circuitry of a central unit (CU), of a radio access network (RAN) node, that is coupled to a plurality of distributed units (DUs) of the RAN node, configure the CU to perform operations corresponding to any of the methods of embodiments B1-B13.
E4. A computer program product comprising computer-executable instructions that, when executed by processing circuitry of a central unit (CU), of a radio access network (RAN) node, that is coupled to a plurality of distributed units (DUs) of the RAN node, configure the CU to perform operations corresponding to any of the methods of embodiments B1-B13.
F1. A second distributed unit (DU), of a radio access network (RAN) node, that is coupled to a centralized unit (CU) of the RAN node, the second DU comprising:
   communication interface circuitry configured to communicate with the CU and with UEs via one or more cells provided by the second DU; and
   processing circuitry operably coupled to the communication interface circuitry, whereby the processing circuitry and communication interface circuitry are configured to perform operations corresponding to any of the methods of embodiments C1-C11.
F2. A second distributed unit (DU), of a radio access network (RAN) node, that is coupled to a centralized unit (CU) of the RAN node, the second DU being configured to perform operations corresponding to any of the methods of embodiments C1-C11.
F3. A non-transitory, computer-readable medium storing computer-executable instructions that, when executed by processing circuitry of a second distributed unit (DU), of a radio access network (RAN) node, that is coupled to a centralized unit (CU) of the RAN node, configure the second DU to perform operations corresponding to any of the methods of embodiments C1-C11.
F4. A computer program product comprising computer-executable instructions that, when executed by processing circuitry of a second distributed unit (DU), of a radio access network (RAN) node, that is coupled to a centralized unit (CU) of the RAN node, configure the second DU to perform operations corresponding to any of the methods of embodiments C1-C11.

1.-52. (canceled)

53. A method for a user equipment (UE) configured to communicate with a radio access network (RAN) node comprising a central unit (CU) and a distributed unit (DU), the method comprising:
receiving, from the CU via the DU, a reconfiguration message that includes configurations associated with each of at least one candidate cell for layer1/layer-2 (L1/L2)-based inter-cell mobility from a serving cell provided by the DU, wherein the candidate cells are provided by one or more neighbor DUs;
storing the received configurations;
receiving, from the DU, a lower layer signalling message including a command for the UE to change its serving cell to a first candidate cell, for which a configuration was received in the reconfiguration message; and
performing an L1/L2 mobility procedure towards the first candidate cell and communicating in the first candidate cell according to the stored configuration associated with the first candidate cell.

54. The method of claim 53, wherein the one or more neighbor DUs are associated with the CU and/or are part of the RAN node.

55. The method of claim 53, wherein:
a first one of the configurations includes a corresponding Channel State Information (CSI) measurement configuration in the reconfiguration message; and
the method further comprises performing measurements on the candidate cell associated with the first configuration according to the corresponding CSI measurement configuration.

56. The method of claim 55, wherein:
the CSI measurement configuration includes a CSI reporting configuration; and
performing the measurements includes reporting results of the measurements, performed according to CSI measurement configuration, to the DU according to the CSI reporting configuration.

57. The method of claim 53, further comprising sending, to the CU via the DU, a reconfiguration complete message responsive to the reconfiguration message.

58. The method of claim 53, wherein one or more of the following applies:
the lower layer signaling is at a protocol layer lower than a radio resource control (RRC) protocol layer; and
the lower layer signaling includes one of the following: medium access control (MAC) Control Element (CE), or physical (PHY) Downlink Control Information (DCI).

59. The method of claim 53, wherein communicating in the first candidate cell according to the stored configuration includes one or more of the following:
monitoring a control channel of the first candidate cell in a spatial direction corresponding to a Transmission Configuration Information (TCI) state configuration included in the stored configuration; and
performing a contention-free or a contention-based random access (RA) procedure in the first candidate cell, according to a RA configuration included in the stored configuration.

60. The method of claim 53, wherein one or more of the following applies:
the UE receives the reconfiguration message when the UE is in RRC_CONNECTED state with the RAN; and
the UE receives the reconfiguration message in response to a radio resource control (RRC) Measurement Report sent by the UE.

61. The method of claim 53, wherein:
the first candidate cell is a primary cell (PCell) or a special cell (SpCell) of a cell group provided by a first neighbor DU;
the configuration associated with the first candidate cell includes a configuration for the first candidate cell and configurations for one or more secondary cells (SCells) of the cell group; and
communicating in the first candidate cell according to the stored configuration comprises operating in carrier aggregation with the first neighbor DU using the first candidate cell and the one or more candidate SCells.

62. The method of claim 53, further comprising sending to the CU an indication that the UE is capable of one or more of the following: L1/L2-based inter-cell mobility, and inter-DU L1/L2 based inter-cell mobility.

63. The method of claim 53, wherein the reconfiguration message is an RRCReconfiguration message and is received after security is activated during the UE's initial access to the DU.

64. The method of claim 53, wherein:
the at least one candidate cell include a plurality of candidate cells; and
the reconfiguration message includes a plurality of RRCReconfiguration messages associated respectively with the plurality of candidate cells.

65. A method for a central unit (CU) of a radio access network (RAN) node, the method comprising:
receiving, from a second distributed unit (DU) of the RAN node, configurations associated with each of at least one candidate cell for layer-1/layer-2 (L1/L2)-based inter-cell mobility by a user equipment (UE) from a serving cell provided by a first DU of the RAN node, wherein the at least one candidate cell is provided by the second DU; and
sending, to the first DU for transmission to the UE, a reconfiguration message that includes the configurations associated with the at least one candidate cell provided by the second DU.

66. The method of claim 65, further comprising receiving, from the first DU, a reconfiguration complete message transmitted by the UE in response to the reconfiguration message.

67. The method of claim 65, wherein a first one of the configurations includes a corresponding Channel State Information (CSI) measurement configuration, which is included in the reconfiguration message.

68. The method of claim 65, wherein:
the method further comprises sending, to the second DU, a request to configure the UE for L1/L2-based inter-cell mobility from a serving cell provided by a first DU to at least one candidate cell provided by the second DU; and
the configurations are received in response to the request.

69. The method of claim 68, wherein:
the request to configure the UE is, or is included in, a UE CONTEXT SETUP REQUEST message;
the response to the request is, or is included in, a UE CONTEXT SETUP RESPONSE message; and
the reconfiguration message is sent to the first DU in one of the following: a DL RRC MESSAGE TRANSFER message, or a UE CONTEXT MODIFICATION REQUEST message.

70. The method of claim 68, further comprising receiving from the first DU a message that includes a radio resource control (RRC) Measurement Report sent by the UE, wherein:
the request to configure the UE for L1/L2-based inter-cell mobility is sent in response to the message comprising the RRC Measurement Report; and
the RRC Measurement Report includes one or more UE measurements of the at least one candidate cell provided by the second DU.

71. The method of claim 70, further comprising:
sending, to a third DU of the RAN node, a request to configure the UE for L1/L2-based inter-cell mobility from a serving cell provided by a first DU to the at least one candidate cell provided by the third DU;
receiving, from the third DU in response to the request, configurations associated with each of at least one candidate cell for L1/L2-based inter-cell mobility by the UE, wherein the at least one candidate cell is provided by the third DU.

72. The method of claim 71, wherein the at least one candidate cell provided by the third DU comprises a plurality of candidate cells, and one of the following applies:
the request sent to the third DU comprises a plurality of requests corresponding to the plurality of candidate cells, and a plurality of configurations are received in a corresponding plurality of responses; or
the request sent to the third DU is a single request corresponding to the plurality of candidate cells, and a plurality of configurations are received in a single response.

73. The method of claim 71, wherein one or more of the following applies:
the RRC Measurement Report includes one or more UE measurements of the at least one candidate cell provided by the third DU; and
the reconfiguration message also includes the configurations associated with the at least one candidate cell provided by the third DU.

74. The method of claim 68, wherein:
the method further comprises receiving from the UE an indication that the UE is capable of one or more of the following: L1/L2-based inter-cell mobility, and inter-DU L1/L2 based inter-cell mobility; and
sending the request to configure the UE is based on the indication received from the UE.

75. The method of claim 65, wherein:
the at least one candidate cell include a plurality of candidate cells; and
the reconfiguration message includes a plurality of RRCReconfiguration messages associated respectively with the plurality of candidate cells.

76. A user equipment (UE) configured to communicate with a radio access network (RAN) node comprising a central unit (CU) and a distributed unit (DU), the UE comprising:
communication interface circuitry configured to communicate with the CU and at least the DU via a serving cell; and
processing circuitry operably coupled to the communication interface circuitry, wherein the processing circuitry and communication interface circuitry are configured to:
receive, from the CU via the DU, a reconfiguration message that includes configurations associated with each of at least one candidate cell for layer1/layer-2 (L1/L2)-based inter-cell mobility from a serving cell provided by the DU, wherein the candidate cells are provided by one or more neighbor DUs;
store the received configurations;
receive, from the DU, a lower layer signalling message including a command for the UE to change its serving cell to a first candidate cell, for which a configuration was received in the reconfiguration message; and
perform an L1/L2 mobility procedure towards the first candidate cell and communicate in the first candidate cell according to the stored configuration associated with the first candidate cell.

77. A central unit (CU) of a radio access network (RAN) node, the CU comprising:
communication interface circuitry configured to communicate with a plurality of distributed units (DUs) of the RAN node and with user equipment (UEs) via cells provided by the DUs; and
processing circuitry operably coupled to the communication interface circuitry, whereby the processing circuitry and the communication interface circuitry are configured to:
receive, from a second DU of the RAN node, configurations associated with each of at least one candidate cell for layer1/layer-2 (L1/L2)-based inter-cell mobility by a UE from a serving cell provided by a first DU of the RAN node, wherein the at least one candidate cell is provided by the second DU; and
send, to the first DU for transmission to the UE, a reconfiguration message that includes the configurations associated with the at least one candidate cell provided by the second DU.
